(19) United States
(12) Patent Application Publication
(10) Pub. No.: US 2026/0141705 A1
(43) Pub. Date: May 21, 2026

(54) Translation and Scaling Equivariant Slot Attention

(71) Applicant: Google LLC, Mountain View, CA (US)

(72) Inventors: Aravindh Mahendran, Berlin (DE); Ondrej Biza, Somerville, MA (US); Thomas Kipf, Amsterdam (NL); Simon Jacob van Steenkiste, Mountain View, CA (US); Gamaleldin Elsayed, Miliptas, CA (US); Seyed Mohammad Mehdi Sajjadi, Berlin (DE)

(21) Appl. No.: 19/120,445

(22) PCT Filed: Nov. 15, 2022
(86) PCT No.: PCT/US2022/079903

§ 371 Date: Apr. 11, 2025

Related U.S. Application Data
(60) Provisional application No. 63/379,407, filed on Oct. 13, 2022.

(51) Int. Cl. G06V 10/82; G06V 10/44

(52) U.S. Cl. CPC G06V 10/82; G06V 10/44

(57) ABSTRACT

A method includes receiving feature vectors and, for each respective feature vector, a corresponding absolute positional encoding. The method also includes determining latent representations of entities represented by the feature vectors, and determining, for each respective latent representation, a corresponding relative positional encoding based on the corresponding absolute positional encoding of each feature vector and a corresponding position vector associated with the respective latent representation. The method additionally includes determining an attention matrix based on the feature vectors, the entity-centric latent representations, and the corresponding relative positional encoding of each latent representation. The method further includes updating, for each respective latent representation, the corresponding position vector based on a weighted mean of the corresponding absolute positional encoding of each feature vector weighted according to corresponding entries of the attention matrix, and outputting the latent representations and/or the position vectors associated therewith.

### CROSS REFERENCE TO RELATED APPLICATIONS

This application claims priority to U.S. provisional patent application No. 63/379,407, filed on Oct. 13, 2022, which is hereby incorporated by reference as if fully set forth in this description.

### BACKGROUND

Machine Learning models may be used to process various types of data, including images, video, time series, text, and/or point clouds, among other possibilities. Improvements in the machine learning models may allow the models to carry out the processing of data faster and/or utilize fewer computing resources for the processing. Improvements in the machine learning models may also allow the models to generate outputs that are relatively more accurate, precise, and/or otherwise improved.

### SUMMARY

An attention-based machine learning model may be configured to generate entity-centric latent representations of entities (e.g., objects) represented by a plurality of feature vectors that form a distributed representation of features identified in input data (e.g., convolutional features identified in an image). The distributed representation may be associated with an absolute positional encoding in a reference frame of the input data. The attention-based machine learning model may be configured to explicitly represent positions and/or scales of the entities using entity-centric position vectors and/or entity-centric scale vectors, respectively. The entity-centric latent representations may be generated based on relative positional encodings determined by shifting the distributed representation according to the entity-centric position vectors and/or scaling the distributed representation according to the entity-centric scale vectors. The relative positional encoding may allow each entity-centric representation to perceive features of the distributed representation relative to its own reference frame, rather than relative to the reference frame of the input data, and thereby allow entity attributes to be disentangled from entity position and/or scale. Thus, entity position and/or size may be represented separately from entity attributes, thereby allowing the position and/or size of entities to be modified independently of entity attributes.

In a first example embodiment, a method may include receiving input data that includes (i) a plurality of feature vectors and (ii), for each respective feature vector of the plurality of feature vectors, a corresponding absolute positional encoding in a reference frame of the input data. The method also includes determining a plurality of entity-centric latent representations of corresponding entities represented by the input data. The method additionally includes determining, for each respective entity-centric latent representation of the plurality of entity-centric latent representations, a corresponding relative positional encoding in a reference frame of the respective entity-centric latent representation based on (i) the corresponding absolute positional encoding of each respective feature vector and (ii) a corresponding entity-centric position vector associated with the respective entity-centric latent representation. The method yet additionally includes determining an attention matrix based on (i) the plurality of feature vectors transformed by a key function, (ii) the plurality of entity-centric latent representations transformed by a query function, and (iii) the corresponding relative positional encoding of each respective entity-centric latent representation. The method further includes updating, for each respective entity-centric latent representation of the plurality of entity-centric latent representations, the corresponding entity-centric position vector based on a weighted mean of the corresponding absolute positional encoding of each respective feature vector weighted according to corresponding entries of the attention matrix. The method yet further includes outputting one or more of the plurality of entity-centric latent representations or the corresponding entity-centric position vector associated with each respective entity-centric latent representation.

In a second example embodiment, a system may include a processor and a non-transitory computer-readable medium having stored thereon instructions that, when executed by the processor, cause the processor to perform operations in accordance with the first example embodiment.

In a third example embodiment, a non-transitory computer-readable medium may have stored thereon instructions that, when executed by a computing device, cause the computing device to perform operations in accordance with the first example embodiment.

In a fourth example embodiment, a system may include various means for carrying out each of the operations of the first example embodiment.

These, as well as other embodiments, aspects, advantages, and alternatives, will become apparent to those of ordinary skill in the art by reading the following detailed description, with reference where appropriate to the accompanying drawings. Further, this summary and other descriptions and figures provided herein are intended to illustrate embodiments by way of example only and, as such, that numerous variations are possible. For instance, structural elements and process steps can be rearranged, combined, distributed, eliminated, or otherwise changed, while remaining within the scope of the embodiments as claimed.

### BRIEF DESCRIPTION OF THE DRAWINGS

FIG. 1 illustrates a computing system, in accordance with examples described herein.

FIG. 2 illustrates a computing device, in accordance with examples described herein.

FIG. 3 illustrates a slot attention model, in accordance with examples described herein.

FIG. 4 illustrates slot vectors, in accordance with examples described herein.

FIG. 5 illustrates an equivariant slot attention model, in accordance with examples described herein.

FIG. 6 illustrates adjustments to entity-centric position and scale vectors, in accordance with examples described herein.

FIG. 7 illustrates a flow chart, in accordance with examples described herein.

### DETAILED DESCRIPTION

Example methods, devices, and systems are described herein. It should be understood that the words “example” and “exemplary” are used herein to mean “serving as an example, instance, or illustration.” Any embodiment or feature described herein as being an “example,” “exemplary,” and/or “illustrative” is not necessarily to be construed as preferred or advantageous over other embodiments or features unless stated as such. Thus, other embodiments can be utilized and other changes can be made without departing from the scope of the subject matter presented herein.

Accordingly, the example embodiments described herein are not meant to be limiting. It will be readily understood that the aspects of the present disclosure, as generally described herein, and illustrated in the figures, can be arranged, substituted, combined, separated, and designed in a wide variety of different configurations.

Further, unless context suggests otherwise, the features illustrated in each of the figures may be used in combination with one another. Thus, the figures should be generally viewed as component aspects of one or more overall embodiments, with the understanding that not all illustrated features are necessary for each embodiment.

Additionally, any enumeration of elements, blocks, or steps in this specification or the claims is for purposes of clarity. Thus, such enumeration should not be interpreted to require or imply that these elements, blocks, or steps adhere to a particular arrangement or are carried out in a particular order. Unless otherwise noted, figures are not drawn to scale.

### I. OVERVIEW

A slot attention model may be configured to determine entity-centric (e.g., object-centric) latent representations of entities contained in input data based on a distributed representation of the perceptual representation. For example, an image may contain therein one or more entities, such as objects, surfaces, regions, backgrounds, or other environmental features. Machine learning models may be configured to generate the distributed representation of the image. For example, one or more convolutional neural networks may be configured to process the image and generate one or more convolutional feature maps, which may represent the output of various feature filters implemented by the one or more convolutional neural networks.

These convolutional feature maps may be considered a distributed representation of the entities in the image because the features represented by the feature maps are related to different portions along the image area, but are not directly/explicitly associated with any of the entities represented in the image data. On the other hand, an entity-centric latent representation may associate one or more features with individual entities represented in the image data. Thus, for example, each feature in a distributed representation may be associated with a corresponding portion of the perceptual representation, while each feature in an entity-centric representation may be associated with a corresponding entity contained in the perceptual representation.

Accordingly, the slot attention model may be configured to generate a plurality of entity-centric latent representations, which may be referred to herein as slot vectors, based on a plurality of distributed representations, referred to herein as feature vectors. Each slot vector may be an entity-specific semantic embedding that represents the attributes or properties of one or more corresponding entities. Additionally or alternatively, entity-centric latent representations may be generated using other attention-based models that may differ from the slot attention model.

The plurality of slot vectors may be used by one or more machine learning models (e.g., decoder models) to perform specific tasks, such as image reconstruction, text translation, object attribute/property detection, reward prediction, visual reasoning, question answering, control, and/or planning, among other possible tasks. Thus, the slot attention model may be trained jointly with the one or more decoder models to generate slot vectors that are useful in carrying out the particular task of the one or more decoder models. That is, the slot attention model may be trained to generate the slot vectors in a task-specific manner, such that the slot vectors represent the information important for the particular task and omit information that is not important and/or irrelevant for the particular task.

In some implementations, a decoder model used in training may subsequently be replaced with a different, task-specific decoder or other machine learning model. This task-specific decoder may be trained to interpret the slot vectors generated by the system in the context of a particular task and generate task-specific outputs, thus allowing the system to be used in various contexts and applications. In one example, the particular task may include controlling a robotic device, and so the task-specific decoder may thus be trained to use the information represented by the slot vectors to facilitate controlling the robotic device. In another example, the particular task may include operating an autonomous vehicle, and so the task-specific decoder may thus be trained to use the information represented by the slot vectors to facilitate operating the autonomous vehicle. Additionally, since the system operates on feature vectors, any input data and/or sequence thereof from which feature vectors can be generated may be processed by the system. Thus, the system may be applied to (e.g., configured to process), and/or may be used to generate as output, video(s), point cloud(s), waveform(s) (e.g., audio waveforms represented as spectrograms), text, RADAR data, and/or other computer-generated and/or human-generated data.

Although the slot attention model may be trained for a specific task, the architecture of the slot attention model is not task-specific and thus allows the slot attention model to be used for various tasks. The slot attention model may be used for both supervised and unsupervised training tasks. Additionally, the slot attention model does not assume, expect, or depend on the feature vectors representing a particular type of data (e.g., image data, point cloud data, waveform data, text data, etc.). Thus, the slot attention model may be used with any type of data that can be represented by one or more feature vectors, and the type of data may be based on the task for which the slot attention model is used.

Further, the slot vectors themselves might not be specialized with respect to particular entity types and/or classifications. Thus, when multiple classes of entities are contained within the perceptual representation, each slot vector may be capable of representing each of the entities, regardless of its class. Each of the slot vectors may bind to or attach to a particular entity in order to represent its features, but this binding/attending is not dependent on entity type, classification, and/or semantics. The binding/attending of a slot vector to an entity may be driven by the downstream task for which the slot vectors are used—the slot attention model might not be “aware” of objects per-se, and might not distinguish between, for example, clustering objects, colors, and/or spatial regions.

In some implementations, entity-centric latent representations (e.g., slot vectors) of features present within an input data sequence may be generated, tracked, and/or updated based on multiple input frames of the input data sequence. For example, slot vectors representing objects present in a video may be generated, tracked, and/or updated across different image frames of the video. Specifically, rather than processing each input frame independently, the input frames may be processed as a sequence, with prior slot vectors providing information that may be useful in generating subsequent slot vectors. Accordingly, the slot vectors generated for the input data sequence may be temporally-coherent, with a given slot representing the same entity and/or feature across multiple input frames of the input data sequence.

In some implementations, the slot attention model may be configured to learn spatial symmetries that could be present in the input data. Thus, information about entity position and scale may be at least partially entangled or intertwined with information about other entity attributes. Such a model might not be symmetric with respect to translation and/or scale, and may be relatively parameter-inefficient at determining spatial properties of entities.

Accordingly, the slot attention model may be modified to explicitly represent entity position and/or scale, thereby making the slot attention model equivariant to translation and/or scale. Specifically, each respective slot vector may be associated with a corresponding position vector and/or a corresponding scale vector defining, respectively, a position and/or scale within the input data of an entity represented by the respective slot vector. The corresponding position vector may be based on a center of mass of the respective slot vector within an attention matrix of the slot attention model. The corresponding scale vector may be based on a spread/span (e.g., region occupied by) the respective slot vector with the attention matrix of the slot attention model.

The corresponding position and/or scale vectors may be used to adjust absolute positional encodings associated with the feature vectors into a respective reference frame of each respective slot vector. Specifically, for each respective slot vector, the absolute positional encodings may be offset (i.e., shifted) according to the corresponding position vector and scaled according to the corresponding scale vector, thereby determining corresponding relative positional encodings. The corresponding relative positional encodings may allow the respective slot vector to “perceive” features of the input data relative to itself and independently of entity position and scale. The corresponding relative positional encodings may be provided as input to portions of the slot attention model that are configured to determine values of the slot vectors.

Accordingly, two instances of the same entity, each located at a different position within the input data and/or having a different size within the input data, may be represented using respective slot vectors that are substantially and/or approximately equal (i.e., very similar, as quantified using a vector distance metric). Thus, the information stored in each slot vector may be independent of entity position and size/scale. The corresponding position and scale vectors of these two instances of the same entity may differ in accordance with the respective position and size of each entity. Thus, symmetry to entity translation and/or scale might not need to be learned and implicitly encoded in the parameters of the slot attention model, and may instead be explicitly represented using the corresponding position and feature vectors.

### II. EXAMPLE COMPUTING DEVICES

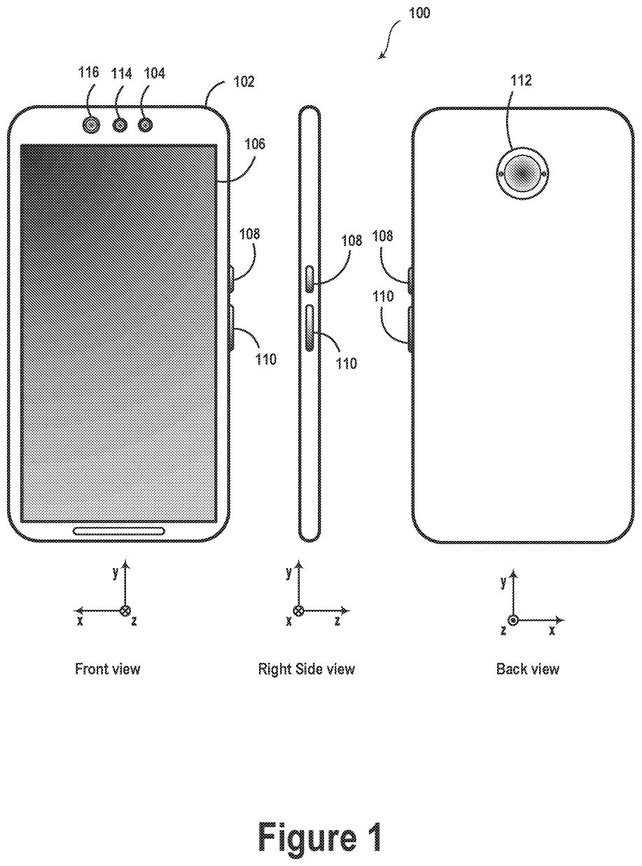

FIG. 1 illustrates an example form factor of computing system 100. Computing system 100 may be, for example, a mobile phone, a tablet computer, or a wearable computing device. However, other embodiments are possible. Computing system 100 may include various elements, such as body 102, display 106, and buttons 108 and 110. Computing system 100 may further include front-facing camera 104, rear-facing camera 112, front-facing infrared camera 114, and infrared pattern projector 116.

Front-facing camera 104 may be positioned on a side of body 102 typically facing a user while in operation (e.g., on the same side as display 106). Rear-facing camera 112 may be positioned on a side of body 102 opposite front-facing camera 104. Referring to the cameras as front and rear facing is arbitrary, and computing system 100 may include multiple cameras positioned on various sides of body 102. Front-facing camera 104 and rear-facing camera 112 may each be configured to capture images in the visible light spectrum.

Display 106 could represent a cathode ray tube (CRT) display, a light emitting diode (LED) display, a liquid crystal (LCD) display, a plasma display, an organic light emitting diode (OLED) display, or any other type of display known in the art. In some embodiments, display 106 may display a digital representation of the current image being captured by front-facing camera 104, rear-facing camera 112, and/or infrared camera 114, and/or an image that could be captured or was recently captured by one or more of these cameras. Thus, display 106 may serve as a viewfinder for the cameras. Display 106 may also support touchscreen functions that may be able to adjust the settings and/or configuration of any aspect of computing system 100.

Front-facing camera 104 may include an image sensor and associated optical elements such as lenses. Front-facing camera 104 may offer zoom capabilities or could have a fixed focal length. In other embodiments, interchangeable lenses could be used with front-facing camera 104. Front-facing camera 104 may have a variable mechanical aperture and a mechanical and/or electronic shutter. Front-facing camera 104 also could be configured to capture still images, video images, or both. Further, front-facing camera 104 could represent a monoscopic, stereoscopic, or multiscopic camera. Rear-facing camera 112 and/or infrared camera 114 may be similarly or differently arranged. Additionally, one or more of front-facing camera 104, rear-facing camera 112, or infrared camera 114, may be an array of one or more cameras.

Either or both of front-facing camera 104 and rear-facing camera 112 may include or be associated with an illumination component that provides a light field in the visible light spectrum to illuminate a target object. For instance, an illumination component could provide flash or constant illumination of the target object. An illumination component could also be configured to provide a light field that includes one or more of structured light, polarized light, and light with specific spectral content. Other types of light fields known and used to recover three-dimensional (3D) models from an object are possible within the context of the embodiments herein.

Infrared pattern projector 116 may be configured to project an infrared structured light pattern onto the target object. In one example, infrared projector 116 may be configured to project a dot pattern and/or a flood pattern. Thus, infrared projector 116 may be used in combination with infrared camera 114 to determine a plurality of depth values corresponding to different physical features of the target object.

Namely, infrared projector 116 may project a known and/or predetermined dot pattern onto the target object, and infrared camera 114 may capture an infrared image of the target object that includes the projected dot pattern. Computing system 100 may then determine a correspondence between a region in the captured infrared image and a particular part of the projected dot pattern. Given a position of infrared projector 116, a position of infrared camera 114, and the location of the region corresponding to the particular part of the projected dot pattern within the captured infrared image, computing system 100 may then use triangulation to estimate a depth to a surface of the target object. By repeating this for different regions corresponding to different parts of the projected dot pattern, computing system 100 may estimate the depth of various physical features or portions of the target object. In this way, computing system 100 may be used to generate a three-dimensional (3D) model of the target object.

Computing system 100 may also include an ambient light sensor that may continuously or from time to time determine the ambient brightness of a scene (e.g., in terms of visible and/or infrared light) that cameras 104, 112, and/or 114 can capture. In some implementations, the ambient light sensor can be used to adjust the display brightness of display 106. Additionally, the ambient light sensor may be used to determine an exposure length of one or more of cameras 104, 112, or 114, or to help in this determination.

Computing system 100 could be configured to use display 106 and front-facing camera 104, rear-facing camera 112, and/or front-facing infrared camera 114 to capture images of a target object. The captured images could be a plurality of still images or a video stream. The image capture could be triggered by activating button 108, pressing a softkey on display 106, or by some other mechanism. Depending upon the implementation, the images could be captured automatically at a specific time interval, for example, upon pressing button 108, upon appropriate lighting conditions of the target object, upon moving computing system 100 a predetermined distance, or according to a predetermined capture schedule.

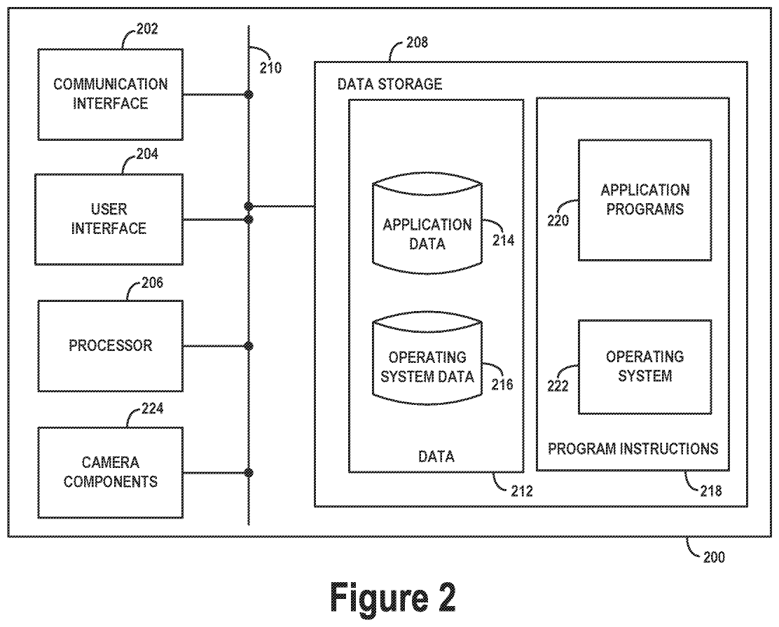

As noted above, the functions of computing system 100 may be integrated into a computing device, such as a wireless computing device, cell phone, tablet computer, laptop computer and so on. For purposes of example, FIG. 2 is a simplified block diagram showing some of the components of an example computing device 200 that may include camera components 224.

By way of example and without limitation, computing device 200 may be a cellular mobile telephone (e.g., a smartphone), a still camera, a video camera, a computer (such as a desktop, notebook, tablet, or handheld computer), personal digital assistant (PDA), a home automation component, a digital video recorder (DVR), a digital television, a remote control, a wearable computing device, a gaming console, a robotic device, or some other type of device. As shown in FIG. 2, computing device 200 may include communication interface 202, user interface 204, processor 206, data storage 208, and camera components 224, all of which may be communicatively linked together by a system bus, network, or other connection mechanism 210.

Communication interface 202 may allow computing device 200 to communicate, using analog or digital modulation, with other devices, access networks, and/or transport networks. Thus, communication interface 202 may facilitate circuit-switched and/or packet-switched communication, such as plain old telephone service (POTS) communication and/or Internet protocol (IP) or other packetized communication. For instance, communication interface 202 may include a chipset and antenna arranged for wireless communication with a radio access network or an access point. Also, communication interface 202 may take the form of or include a wireline interface, such as an Ethernet, Universal Serial Bus (USB), or High-Definition Multimedia Interface (HDMI) port. Communication interface 202 may also take the form of or include a wireless interface, such as a Wi-Fi, BLUETOOTH®, global positioning system (GPS), or wide-area wireless interface (e.g., WiMAX or 3GPP Long-Term Evolution (LTE)). However, other forms of physical layer interfaces and other types of standard or proprietary communication protocols may be used over communication interface 202. Furthermore, communication interface 202 may comprise multiple physical communication interfaces (e.g., a Wi-Fi interface, a BLUETOOTH® interface, and a wide-area wireless interface).

User interface 204 may function to allow computing device 200 to interact with a human or non-human user, such as to receive input from a user and to provide output to the user. Thus, user interface 204 may include input components such as a keypad, keyboard, touch-sensitive panel, computer mouse, trackball, joystick, microphone, and so on. User interface 204 may also include one or more output components such as a display screen which, for example, may be combined with a touch-sensitive panel. The display screen may be based on CRT, LCD, and/or LED technologies, or other technologies now known or later developed. User interface 204 may also be configured to generate audible output(s), via a speaker, speaker jack, audio output port, audio output device, earphones, and/or other similar devices. User interface 204 may also be configured to receive and/or capture audible utterance(s), noise(s), and/or signal(s) by way of a microphone and/or other similar devices.

In some embodiments, user interface 204 may include a display that serves as a viewfinder for still camera and/or video camera functions supported by computing device 200 (e.g., in both the visible and infrared spectrum). Additionally, user interface 204 may include one or more buttons, switches, knobs, and/or dials that facilitate the configuration and focusing of a camera function and the capturing of images. It may be possible that some or all of these buttons, switches, knobs, and/or dials are implemented by way of a touch-sensitive panel.

Processor 206 may comprise one or more general purpose processors—e.g., microprocessors—and/or one or more special purpose processors—e.g., digital signal processors (DSPs), graphics processing units (GPUs), floating point units (FPUs), network processors, or application-specific integrated circuits (ASICs). In some instances, special purpose processors may be capable of image processing, image alignment, and merging images, among other possibilities. Data storage 208 may include one or more volatile and/or non-volatile storage components, such as magnetic, optical, flash, or organic storage, and may be integrated in whole or in part with processor 206. Data storage 208 may include removable and/or non-removable components.

Processor 206 may be capable of executing program instructions 218 (e.g., compiled or non-compiled program logic and/or machine code) stored in data storage 208 to carry out the various functions described herein. Therefore, data storage 208 may include a non-transitory computer-readable medium, having stored thereon program instructions that, upon execution by computing device 200, cause computing device 200 to carry out any of the methods, processes, or operations disclosed in this specification and/or the accompanying drawings. The execution of program instructions 218 by processor 206 may result in processor 206 using data 212.

By way of example, program instructions 218 may include an operating system 222 (e.g., an operating system kernel, device driver(s), and/or other components) and one or more application programs 220 (e.g., camera functions, address book, email, web browsing, social networking, audio-to-text functions, text translation functions, and/or gaming applications) installed on computing device 200. Similarly, data 212 may include operating system data 216 and application data 214. Operating system data 216 may be accessible primarily to operating system 222, and application data 214 may be accessible primarily to one or more of application programs 220. Application data 214 may be arranged in a file system that is visible to or hidden from a user of computing device 200.

Application programs 220 may communicate with operating system 222 through one or more application programming interfaces (APIs). These APIs may facilitate, for instance, application programs 220 reading and/or writing application data 214, transmitting or receiving information via communication interface 202, receiving and/or displaying information on user interface 204, and so on. In some vernaculars, application programs 220 may be referred to as “apps” for short. Additionally, application programs 220 may be downloadable to computing device 200 through one or more online application stores or application markets. However, application programs can also be installed on computing device 200 in other ways, such as via a web browser or through a physical interface (e.g., a USB port) on computing device 200.

Camera components 224 may include, but are not limited to, an aperture, shutter, recording surface (e.g., photographic film and/or an image sensor), lens, shutter button, infrared projectors, and/or visible-light projectors. Camera components 224 may include components configured for capturing of images in the visible-light spectrum (e.g., electromagnetic radiation having a wavelength of 400-700 nanometers) and components configured for capturing of images in the infrared light spectrum (e.g., electromagnetic radiation having a wavelength of 701 nanometers-1 millimeter). Camera components 224 may be controlled at least in part by software executed by processor 206.

### III. EXAMPLE SLOT ATTENTION MODEL

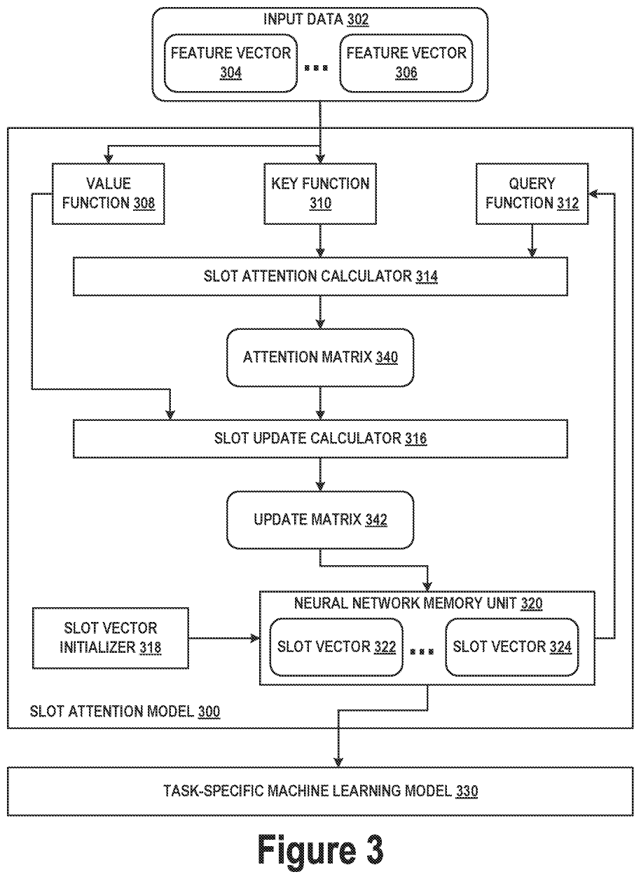

FIG. 3 illustrates a block diagram of slot attention model 300. Slot attention model 300 may include value function 308, key function 310, query function 312, slot attention calculator 314, slot update calculator 316, slot vector initializer 318, and neural network memory unit 320. Slot attention model 300 may be configured to receive input data 302 as input, which may include feature vectors 304-306. Input data 302 may alternatively be referred to as a perceptual representation. Input data 302 may correspond to and/or represent an input frame of an input data sequence (e.g., an image frame of a video, a snapshot of a point cloud).

Slot attention model 300 may be configured to generate slot vectors 322-324 based on input data 302. Feature vectors 304-306 may represent a distributed representation of the entities in input data 302, while slot vectors 322-324 may represent an entity-centric representation of these entities. Slot vectors 322-324 provide one example of entity-centric latent representations of the entities in input data 302. Slot attention model 300 and the components thereof may represent a combination of hardware and/or software components configured to implement the functions described herein. Slot vectors 322-324 may collectively define latent representation of input data 302. In some cases, the latent representation may represent an entity-specific compression of the information contained in input data 302. Thus, in some implementations, slot attention model 300 may be used as and/or viewed as a machine learning encoder. Accordingly, slot attention model 300 may be used for image reconstruction, text translation, and/or other applications that utilize machine learning encoders. Unlike certain other latent representations, each slot vector of this latent representation may capture the properties of corresponding one or more entities in input data 302, and may do so without relying on assumption about an order in which the entities are described by input data 302.

Input data 302 may represent various types of data, including, for example, image data (e.g., red-green-blue image data or grayscale image data), depth image data, point cloud data, audio data, time series data, and/or text data, among other possibilities. In some cases, input data 302 may be captured and/or generated by one or more sensors, such as visible light cameras (e.g., camera 104), near-infrared cameras (e.g., infrared camera 114), thermal cameras, stereoscopic cameras, time-of-flight (ToF) cameras, light detection and ranging (LIDAR) devices, radio detection and ranging (RADAR) devices, and/or microphones, among other possibilities. In other cases, input data 302 may additionally or alternatively include data generated by one or more users (e.g., words, sentences, paragraphs, and/or documents) or computing devices (e.g., rendered three-dimensional environments, time series plots), among other possibilities.

Input data 302 may be processed by way of one or more machine learning models (e.g., by an encoder model) to generate feature vectors 304-306. Each feature vector of feature vectors 304-306 may include a plurality of values, with each value corresponding to a particular dimension of the feature vector. In some implementations, the plurality of values of each feature vector may collectively represent an embedding of at least a portion of input data 302 in a vector space defined by the one or more machine learning models. When input data 302 is an image, for example, each of feature vectors 304-306 may be associated with one or more pixels in the image, and may represent the various visual features of the one or more pixels. In some cases, the one or more machine learning models used to process input data 302 may include convolutional neural networks. Accordingly, feature vectors 304-306 may represent a map of convolutional features of input data 302, and may thus include the outputs of various convolutional filters.

Each respective feature vector of feature vectors 304-306 may be associated with a position embedding and/or encoding (e.g., an absolute positional encoding) that indicates a portion of input data 302 represented by the respective feature vector. Feature vectors 304-306 may be determined, for example, by adding the position embedding/encoding to the convolutional features extracted from input data 302. Encoding the position associated with each respective feature vector of feature vectors 304-306 as part of the respective feature vector, rather than by way of the order in which the respective feature vector is provided to slot attention model 300, allows feature vectors 304-306 to be provided to slot attention model 300 in a plurality of different orders. Thus, including the position embeddings/encodings as part of feature vectors 304-306 enables slot vectors 322-324 generated by slot attention model 300 to be permutation invariant with respect to feature vectors 304-306.

In the case of an image, for example, the position embedding/encoding may be generated by constructing a W×H×4 tensor, where W and H represent the width and height, respectively, of the map of the convolutional features of input data 302. Each of the four values associated with each respective pixel along the W×H map may represent a position of the respective pixel relative to a border, boundary, and/or edge of the image along a corresponding direction (i.e., up, down, right, and left) of the image. In some cases, each of the four values may be normalized to a range from 0 to 1, inclusive. In some implementations, the position embedding/encoding may instead be represented by a W×H×2 tensor, with each of the two values associated with each respective pixel along the W×H map representing a position relative to a fixed reference point (e.g., relative to pixel (0, 0) in the top left corner of the image). The W×H×4 tensor may be projected to the same dimension as the convolutional features (i.e., the same dimension as feature vectors 304-306) by way of a learnable linear map. The projected W×H×4 tensor may then be added to the convolutional features to generate feature vectors 304-306, thereby embedding feature vectors 304-306 with positional information. In some implementations, the sum of the projected W×H×4 tensor and the convolutional features may be processed by one or more machine learning models (e.g., one or more multi-layer perceptrons) to generate feature vectors 304-306. Similar position embeddings may be included in feature vectors 304-306 for other types of input data as well.

Feature vectors 304-306 may be provided as input to key function 310. Feature vectors 304-306 may include N vectors each having Dᵢₙₚᵤₜₛ values. Thus, in some implementations, feature vectors 304-306 may be represented by an input matrix X having N rows (each corresponding to a particular feature vector) and Dᵢₙₚᵤₜₛ columns.

In some implementations, key function 310 may include a linear transformation represented by a key weight matrix W_{KEY} having Dᵢₙₚᵤₜₛ rows and D columns, and/or a non-linear transformation. For example, key function 310 may include a multi-layer perceptron that includes one or more hidden layers and that utilizes one or more non-linear activation functions. Key function 310 (e.g., key weight matrix W_{KEY}) may be learned during training of slot attention model 300. The input matrix X may be transformed by key function 310 to generate a key input matrix X_{KEY} (e.g., X_{KEY}=XW_{KEY}), which may be provided as input to slot attention calculator 314. Key input matrix X_{KEY} may include N rows and D columns.

Feature vectors 304-306 may also be provided as input to value function 308. In some implementations, value function 308 may include a linear transformation represented by a value weight matrix W_{VALUE} having Dᵢₙₚᵤₜₛ rows and D columns, and/or a non-linear transformation. For example, value function 308 may include a multi-layer perceptron that includes one or more hidden layers and that utilizes one or more non-linear activation functions. Value function 308 (e.g., value weight matrix W_{VALUE}) may be learned during training of slot attention model 300. The input matrix X may be transformed by value function 308 to generate a value input matrix X_{VALUE} (e.g., X_{VALUE}=XW_{VALUE}), which may be provided as input to slot update calculator 316. Value input matrix X_{VALUE} may include N rows and D columns.

Since the dimensions of key weight matrix W_{KEY} and the value weight matrix W_{VALUE} do not depend on the number N of feature vectors 304-306, different values of N may be used during training and during testing/usage of slot attention model 300. For example, slot attention model 300 may be trained on perceptual inputs with N=1024 feature vectors, but may be used with N=512 feature vectors or N=2048 feature vectors. However, since at least one dimension of the key weight matrix W_{KEY} and the value weight matrix W_{VALUE} does depend on the dimension Dᵢₙₚᵤₜₛ of feature vectors 304-306, the same value of Dᵢₙₚᵤₜₛ may be used during training and during testing/usage of slot attention model 300.

Slot vector initializer 318 may be configured to initialize each of slot vectors 322-324 stored by neural network memory unit 320. In one example, slot vector initializer 318 may be configured to initialize each of slot vectors 322-324 with random values selected, for example, from a normal (i.e., Gaussian) distribution. In other examples, slot vector initializer 318 may be configured to initialize one or more respective slot vectors of slot vectors 322-324 with “seed” values configured to cause the one or more respective slot vectors to attend/bind to, and thereby represent, a particular entity contained within input data 302. For example, when processing image frames of a video, slot vector initializer 318 may be configured to initialize slot vectors 322-324 for a second image frame based on the values of the slot vectors 322-324 determined with respect to a first image frame that precedes the second image frame. Accordingly, a particular slot vector of slot vectors 322-324 may be caused to represent the same entity across image frames of the video. Other types of sequential data may be similarly “seeded” by slot vector initializer 318.

Slot vectors 322-324 may include K vectors each having Dₛₗₒₜ values. Thus, in some implementations, slot vectors 322-324 may be represented by an output matrix Y having K rows (each corresponding to a particular slot vector) and Dₛₗₒₜ columns.

In some implementations, query function 312 may include a linear transformation represented by a query weight matrix W_{QUERY} having Dₛₗₒₜ rows and D columns, and/or a non-linear transformation. For example, query function 312 may include a multi-layer perceptron that includes one or more hidden layers and that utilizes one or more non-linear activation functions. Query function 312 (e.g., query weight matrix W_{QUERY}) may be learned during training of slot attention model 300. The output matrix Y may be transformed by query function 312 to generate a query input matrix Y_{QUERY} (e.g., Y_{QUERY}=YW_{QUERY}), which may be provided as input to slot attention calculator 314. Query output matrix Y_{QUERY} may include K rows and D columns. Thus, the dimension D may be shared by value function 308, key function 310, and query function 312.

Further, since the dimensions of the query weight matrix W_{QUERY} do not depend on the number K of slot vectors 322-324, different values of K may be used during training and during testing/usage of slot attention model 300. For example, slot attention model 300 may be trained with K=7 slot vectors, but may be used with K=5 slot vectors or K=11 slot vectors. Thus, slot attention model 300 may be configured to generalize across different numbers of slot vectors 322-324 without explicit training, although training and using slot attention model 300 with the same number of slot vectors 322-324 may improve performance. However, since at least one dimension of the query weight matrix W_{QUERY} does depend on the dimension Dₛₗₒₜ of slot vectors 322-324, the same value of Dₛₗₒₜ may be used during training and during testing/usage of slot attention model 300.

Slot attention calculator 314 may be configured to determine attention matrix 340 based on key input matrix X_{KEY} generated by key function 310 and query input matrix Y_{QUERY} generated by query function 312. Specifically, slot attention calculator 314 may be configured to calculate a dot product between key input matrix X_{KEY} and a transpose of query output matrix Y_{QUERY}. In some implementations, slot attention calculator 314 may also divide the dot product by the square root of D (i.e., the number of columns of the W_{VALUE}, W_{KEY}, and/or W_{QUERY} matrices) or the square root of K. Thus, slot attention calculator 314 may implement the function M=(1/\sqrt{D})X_{KEY}(Y_{QUERY})^{T}, where M represents a non-normalized version of attention matrix 340 and may include N rows and K columns.

Slot attention calculator 314 may be configured to determine attention matrix 340 by normalizing the values of the matrix M with respect to the output axis (i.e., with respect to slot vectors 322-324). Thus, the values of the matrix M may be normalized along the rows thereof (i.e., along the dimension K corresponding to the number of slot vectors 322-324). Accordingly, each value in each respective row may be normalized with respect to the K values contained in the respective row.

Thus, slot attention calculator 314 may be configured to determine attention matrix 340 by normalizing each respective value of a plurality of values of each respective row of the matrix M with respect to the plurality of values of the respective row. Specifically, slot attention calculator 314 may determine attention matrix 340 according to

$${A}_{i , j} = ( {e}^{{M}_{i , j}} ) / ( {\sum }_{l = 1}^{K} {e}^{{M}_{i , l}} ) ,$$

where A_{i,j} indicates the value at a position corresponding to row i and column j of attention matrix 340, which may be alternatively referred to as attention matrix A. Normalizing the matrix M in this manner may cause slots to compete with one another for representing a particular entity. The function implemented by slot attention calculator 314 for computing A_{i,j} may be referred to as a softmax function. Attention matrix A (i.e., attention matrix 340) may include N rows and K columns.

In other implementations, the matrix M may be transposed prior to normalization, and the values of the matrix M^{T} may thus be normalized along the columns thereof (i.e., along the dimension K corresponding to the number of slot vectors 322-324). Accordingly, each value in each respective column of the matrix M^{T} may be normalized with respect to the K values contained in the respective column. Slot attention calculator 314 may determine a transposed version of attention matrix 340 according to

$${A}_{i , j}^{T} = ( {e}^{{M}_{i , j}} ) / ( {\sum }_{l = 1}^{K} {e}^{{M}_{l , j}} ) ,$$

where

$${A}_{i , j}^{T}$$

indicates the value at a position corresponding to row i and column j of transposed attention matrix 340, which may be alternatively referred to as transposed attention matrix A^{T}. Nevertheless, transposed attention matrix 340 may still be determined by normalizing the values of the matrix M with respect to the output axis (i.e., with respect to slot vectors 322-324).

Slot update calculator 316 may be configured to determine update matrix 342 based on value input matrix X_{VALUE} generated by value function 308 and attention matrix 340. In one implementation, slot update calculator 316 may be configured to determine update matrix 342 by determining a dot product of a transpose of the attention matrix A and the value input matrix X_{VALUE}. Thus, slot update calculator 316 may implement the function U_{WEIGHTED SUM}=A^{T}X_{VALUE}, where the attention matrix A may be viewed as specifying the weights of a weighted sum calculation and the value input matrix X_{VALUE} may be viewed as specifying the values of the weighted sum calculation. Update matrix 342 may thus be represented by U_{WEIGHTED SUM}, which may include K rows and D columns.

In another implementation, slot update calculator 316 may be configured to determine update matrix 342 by determining a dot product of a transpose of an attention weight matrix W^{ATTENTION} and the value input matrix X_{VALUE}. Elements/entries of the attention weight matrix W^{ATTENTION} may be defined as

$${W}_{i , j}^{A T T ENTION} = ( {A}_{i , j} ) / ( {\sum }_{l = 1}^{N} {A}_{l , j} ) ,$$

or, for the transpose thereof, as

$${( {W}_{i , j}^{A T T ENTION} )}^{T} = ( {A}_{i , j}^{T} ) / ( {\sum }_{l = 1}^{N} {A}_{i , l}^{T} ) .$$

Thus, slot update calculator 316 may implement the function

$${U}_{WEIGHTED MEAN} = {( {W}^{A T T ENTION} )}^{T} {X}_{V A L U E} ,$$

where the matrix A may be viewed as specifying the weights of a weighted mean calculation and the value input matrix X_{VALUE} may be viewed as specifying the values of the weighted mean calculation. Update matrix 342 may thus be represented by U_{WEIGHTED MEAN}, which may include K rows and D columns.

Update matrix 342 may be provided as input to neural network memory unit 320, which may be configured to update slot vectors 322-324 based on the previous values of slot vectors 322-324 (or intermediate slot vectors generated based on slot vectors 322-324) and update matrix 342. Neural network memory unit 320 may include a gated recurrent unit (GRU) and/or a long-short term memory (LSTM) network, as well as other neural network or machine learning-based memory units configured to store and/or update slot vectors 322-324. For example, in addition to a GRU and/or an LSTM, neural network memory unit 320 may include one or more feed-forward neural network layers configured to further modify the values of slot vectors 322-324 after modification by the GRU and/or LSTM (and prior to being provided to task-specific machine learning model 330).

In some implementations, neural network memory unit 320 may be configured to update each of slot vectors 322-324 during each processing iteration, rather than updating only some of slot vectors 322-324 during each processing iteration. Training neural network memory unit 320 to update the values of slot vectors 322-324 based on the previous values thereof (or intermediate slot vectors generated based on slot vectors 322-324) and based on update matrix 342, rather than using update matrix 342 as the updated values of slot vectors 322-324, may improve the accuracy and/or speed up convergence of slot vectors 322-324.

Slot attention model 300 may be configured to generate slot vectors 322-324 in an iterative manner. That is, slot vectors 322-324 may be updated one or more times before being passed on as input to task-specific machine learning model 330. For example, slot vectors 322-324 may be updated three times before being considered “ready” to be used by task-specific machine learning model 330. Specifically, the initial values of slot vectors 322-324 may be assigned thereto by slot vector initializer 318. When the initial values are random, they likely will not accurately represent the entities contained in input data 302. Thus, feature vectors 304-306 and the randomly-initialized slot vectors 322-324 may be processed by components of slot attention model 300 to refine the values of slot vectors 322-324, thereby generating updated slot vectors 322-324.

After this first iteration or pass through slot attention model 300, each of slot vectors 322-324 may begin to attend to and/or bind to, and thus represent, one or more corresponding entities contained in input data 302. Feature vectors 304-306 and the now-updated slot vectors 322-324 may again be processed by components of slot attention model 300 to further refine the values of slot vectors 322-324, thereby generating another update to slot vectors 322-324. After this second iteration or pass through slot attention model 300, each of slot vectors 322-324 may continue to attend to and/or bind to the one or more corresponding entities with increasing strength, thereby representing the one or more corresponding entities with increasing accuracy.

Further iterations may be performed, and each additional iteration may generate some improvement to the accuracy with which each of slot vectors 322-324 represents its corresponding one or more entities. After a predetermined number of iterations, slot vectors 322-324 may converge to an approximately stable set of values, resulting in substantially no additional accuracy improvements. Thus, the number of iterations of slot attention model 300 may be selected based on (i) a desired level of representational accuracy for slot vectors 322-324 and/or (ii) desired processing time before slot vectors 322-324 are usable by task-specific machine learning model 330.

Task-specific machine learning model 330 may represent a plurality of different tasks, including both supervised and unsupervised learning tasks. In some implementations, task-specific machine learning model 330 may be co-trained with slot attention model 300. Thus, depending on the specific task associated with task-specific machine learning model 330, slot attention model 300 may be trained to generate slot vectors 322-324 that are adapted for and provide values useful in executing the specific task. Specifically, learned parameters associated with one or more of value function 308, key function 310, query function 312, and/or neural network memory unit 320 may vary as a result of training based on the specific task associated with task-specific machine learning model 330. In some implementations, slot attention model 300 may be trained using adversarial training and/or contrastive learning, among other training techniques.

Slot attention model 300 may take less time to train (e.g., 24 hours, compared to 7 days for an alternative approach executed on the same computing hardware) and consume fewer memory resources (e.g., allowing for a batch size of 64, compared to a batch size of 4 for the alternative approach executed on the same computing hardware) than alternative approaches for determining entity-centric latent representations. In some implementations, slot attention model 300 may also include one or more layer normalizations. For example, layer normalizations may be applied to feature vectors 304-306 prior to the transformation thereof by the key function 310, to slot vectors 322-324 prior to transformation thereof by query function 312, and/or to slot vectors 322-324 after being at least partially updated by neural network memory unit 320. Layer normalizations may improve the stability and speed up the convergence of slot attention model 300.

### IV. EXAMPLE SLOT VECTORS

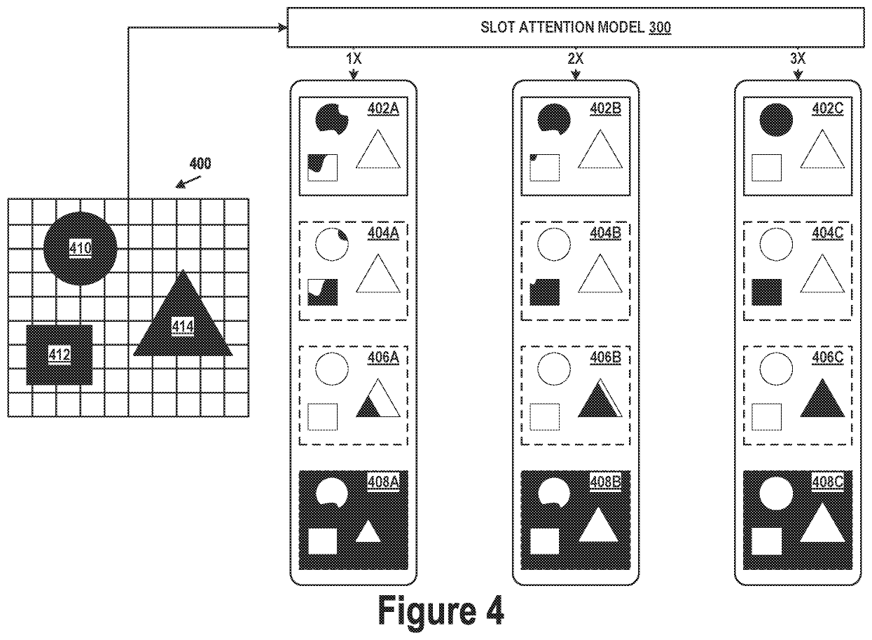

FIG. 4 graphically illustrates an example of a plurality of slot vectors changing over the course of processing iterations by slot attention model 300 with respect to a particular input data. In this example, input data 302 is represented by image 400 that includes three entities: entity 410 (i.e., a circular object); entity 412 (i.e., a square object); and entity 414 (i.e., a triangular object). Image 400 may be processed by one or more machine learning models to generate feature vectors 304-306, each represented by a corresponding grid element of the grid overlaid on top of image 400. Thus, a leftmost grid element in the top row of the grid may represent feature vector 304, a rightmost grid element in the bottom row of the grid may represent feature vector 306, and grid elements therebetween may represent other feature vectors. Thus, each grid element may represent a plurality of vector values associated with the corresponding feature vector.

FIG. 4 illustrates the plurality of slot vectors as having four slot vectors. However, in general, the number of slot vectors may be modifiable. For example, the number of slot vectors may be selected to be at least equal to a number of entities expected to be present in input data 302 so that each entity may be represented by a corresponding slot vector. Thus, in the example illustrated in FIG. 4, the four slot vectors provided exceed the number of entities (i.e., the three entities 410, 412, and 414) contained in image 400. In cases where the number of entities exceeds the number of slot vectors, one or more slot vectors may represent two or more entities.

Slot attention model 300 may be configured to process the feature vectors associated with image 400 and the initial values of the four slot vectors (e.g., randomly initialized) to generate slot vectors with values 402A, 404A, 406A, and 408A. Slot vector values 402A, 404A, 406A, and 408A may represent the output of a first iteration (lx) of slot attention model 300. Slot attention model 300 may also be configured to process the feature vectors and slot vectors with values 402A, 404A, 406A, and 408A to generate slot vectors with values 402B, 404B, 406B, and 408B. Slot vector values 402B, 404B, 406B, and 408B may represent the output of a second iteration (2x) of slot attention model 300. Slot attention model 300 may be further configured to process the feature vectors and slot vectors with values 402B, 404B, 406B, and 408B to generate slot vectors with values 402C, 404C, 406C, and 408C. Slot vector values 402C, 404C, 406C, and 408C may represent the output of a third iteration (3x) of slot attention model 300. The visualizations of slot vector values 402A, 404A, 406A, 408A, 402B, 404B, 406B, 408B, 402C, 404C, 406C, 408C may represent visualizations of attention masks based on attention matrix 340 at each iteration and/or visualizations of reconstruction masks generated by task-specific machine learning model 330, among other possibilities.

The first slot vector (associated with values 402A, 402B, and 402C) may be configured to attend to and/or bind to entity 410, thereby representing attributes, properties, and/or characteristics of entity 410. Specifically, after the first iteration of slot attention model 300, the first slot vector may represent aspects of entity 410 and entity 412, as shown by the black-filled regions in the visualization of slot vector values 402A. After the second iteration of slot attention model 300, the first slot vector may represent a larger portion of entity 410 and a smaller portion of entity 412, as shown by the increased black-filled region of entity 410 and decreased black-filled region of entity 412 in the visualization of slot vector values 402B. After the third iteration of slot attention model 300, the first slot vector may represent entity 410 approximately exclusively, and might no longer represent entity 412, as shown by entity 410 being completely black-filled and entity 412 being illustrate completely white-filled in the visualization of slot vector values 402C. Thus, the first slot vector may converge and/or focus on representing entity 410 as slot attention model 300 updates and/or refines the values of the first slot vector. This attention and/or convergence of a slot vector to one or more entities is a result of the mathematical structure (e.g., the softmax normalization with respect to the output axis corresponding to slot vectors 322-324) of components of slot attention model 300 and task-specific training of slot attention model 300.

The second slot vector (associated with values 404A, 404B, and 404C) may be configured to attend to and/or bind to entity 412, thereby representing attributes, properties, and/or characteristics of entity 412. Specifically, after the first iteration of slot attention model 300, the second slot vector may represent aspects of entity 412 and entity 410, as shown by the black-filled regions in the visualization of slot vector values 404A. After the second iteration of slot attention model 300, the second slot vector may represent a larger portion of entity 412 and might no longer represent entity 410, as shown by the increased black-filled region of entity 412 and entity 410 being illustrated completely white-filled in the visualization of slot vector values 404B. After the third iteration of slot attention model 300, the second slot vector may represent entity 412 approximately exclusively, and might continue to no longer represent entity 410, as shown by entity 412 being completely black-filled and entity 410 being completely white-filled in the visualization of slot vector values 404C. Thus, the second slot vector may converge and/or focus on representing entity 412 as slot attention model updates and/or refines the values of the second slot vector.

The third slot vector (associated with values 406A, 406B, and 406C) may be configured to attend to and/or bind to entity 414, thereby representing attributes, properties, and/or characteristics of entity 414. Specifically, after the first iteration of slot attention model 300, the third slot vector may represent aspects of entity 414, as shown by the black-filled regions in the visualization of slot vector values 406A. After the second iteration of slot attention model 300, the third slot vector may represent a larger portion of entity 414, as shown by the increased black-filled region of entity 414 in the visualization of slot vector values 404B. After the third iteration of slot attention model 300, the third slot vector may represent approximately the entirety of entity 414, as shown by entity 412 being completely black-filled in the visualization of slot vector values 406C. Thus, the third slot vector may converge and/or focus on representing entity 414 as slot attention model updates and/or refines the values of the third slot vector.

The fourth slot vector (associated with values 408A, 408B, and 408C) may be configured to attend to and/or bind to the background features of image 400, thereby representing attributes, properties, and/or characteristics of the background. Specifically, after the first iteration of slot attention model 300, the fourth slot vector may represent approximately the entirety of the background and respective portions of entities 410 and 414 that are not already represented by slot vector values 402A 404A, and/or 406A, as shown by the black-filled region in the visualization of slot vector values 408A. After the second iteration of slot attention model 300, the fourth slot vector may represent approximately the entirety of the background and smaller portions of entities 410 and 414 not already represented by slot vector values 402B 404B, and/or 406B, as shown by the black-filled region of the background and decreased black-filled region of entities 410 and 414 in the visualization of slot vector values 408B. After the third iteration of slot attention model 300, the fourth slot vector may approximately exclusively represent approximately the entirety of the background, as shown by the background being completely black-filled and entities 410, 412, and 414 being completely white-filled in the visualization of slot vector values 408C. Thus, the fourth slot vector may converge and/or focus on representing the background of image 400 as slot attention model updates and/or refines the values of the fourth slot vector.

In some implementations, rather than representing the background of image 400, the fourth slot vector may instead take on a predetermined value indicating that the fourth slot vector is not utilized to represent an entity. Thus, the background may be unrepresented. Alternatively or additionally, when additional slot vectors are provided (e.g., a fifth slot vector), the additional vectors may represent portions of the background or may be unutilized. Thus, in some cases, slot attention model 300 may distribute the representation of the background among multiple slot vectors. In some implementations, the slot vectors might treat the entities within the perceptual representation the same as the background thereof. Specifically, any one of the slot vectors may be used to represent the background and/or an entity (e.g., the background may be treated as another entity). Alternatively, in other implementations, one or more of the slot vectors may be reserved to represent the background.

The plurality of slot vectors may be invariant with respect to an order of the feature vectors and equivariant with respect to one another. That is, for a given initialization of the slot vectors, the order in which the feature vectors are provided at the input to slot attention model 300 does not affect the order and/or values of the slot vectors. However, different initializations of the slot vectors may affect the order of the slot vectors regardless of the order of the feature vectors. Further, for a given set of feature vectors, the set of values of the slot vectors may remain constant, but the order of the slot vectors may be different. Thus, different initializations of the slot vectors may affect the pairings between slot vectors and entities contained in the perceptual representation, but the entities may nevertheless be represented with approximately the same set of slot vector values.

### V. EXAMPLE TRANSLATION AND SCALE EQUIVARIANT SLOT ATTENTION MODEL

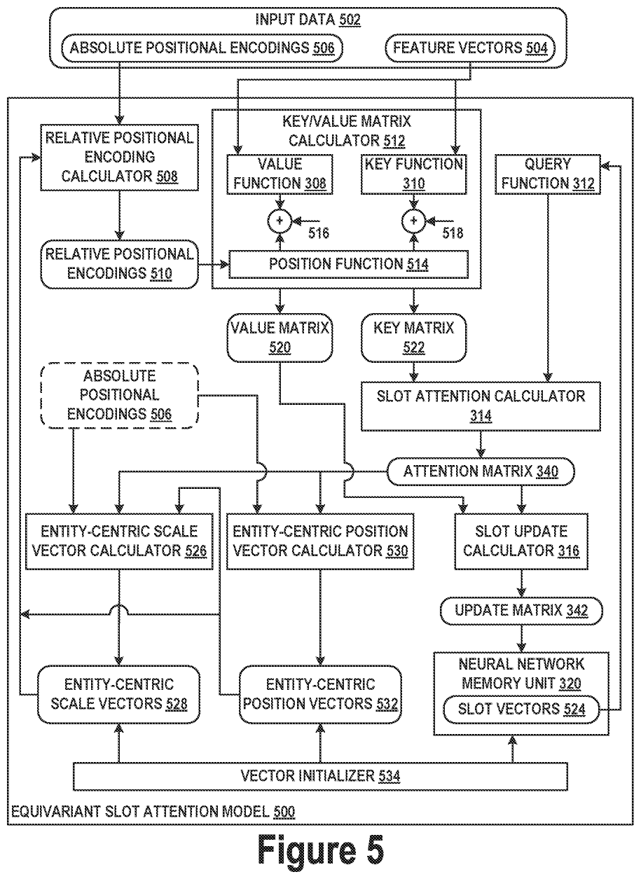

FIG. 5 illustrates a version of slot attention model 300 that is equivariant to position and scale of entities within input data. Specifically, equivariant slot attention model 500 may include relative positional encoding calculator 508, key/value matrix calculator 512, value function 308, key function 310, query function 312, slot attention calculator 314, slot update calculator 316, neural network memory unit 320, entity-centric scale vector calculator 526, entity-centric position vector calculator 530, and vector initializer 534. Value function 308, key function 310, query function 312, slot attention calculator 314, slot update calculator 316, and neural network memory unit 320 may operate as discussed in connection with FIG. 3, although the inputs provided thereto and/or the trained parameters thereof may be different, as discussed below, to provide for translation and scale equivariance.

Equivariant slot attention model 500 may be configured to generate slot vectors 524, entity-centric position vectors 532, and/or entity-centric scale vectors 528 based on input data 502. Input data 502 may include feature vectors 504 and absolute positional encodings 506. Input data 502 may correspond to and/or represent input data 302, as discussed in connection with FIG. 3. Input data 502 may represent any data that can be expressed as a tensor and where translation and/or scale are valid/meaningful concepts that are representable using entity-centric position vectors 532 and/or entity-centric scale vectors 528, respectively. For example, input data 502 may represent an image, a two-dimensional depth map, a three-dimensional map (e.g., point cloud), a waveform, and/or a spectrogram, among other possibilities. Thus, input data 502 may be generated by and/or based on an output of one or more sensors, and may represent aspects of a physical environment.

Feature vectors 504 may represent and/or correspond to feature vectors 304-306 of FIG. 3, with the position embeddings/encodings discussed in connection with FIG. 3 being separately represented by absolute positional encodings 506 rather than being combined with feature vectors 504, as in the case of feature vectors 304-306. Thus, for example, feature vectors 504 may represent convolutional features identified by a machine learning model in input data 502. Feature vectors 504 may be expressed as inputs∈ [symbol] . That is feature vectors 504 may include N vectors each having Dᵢₙₚᵤₜₛ values. Input matrix X, as discussed in connection with FIG. 3, may correspond to inputs (e.g., inputs=X, when the position embeddings/encodings are represented independently of X, rather than combined therewith).

Absolute positional encodings 506 may represent a position of each of feature vectors 504 in a reference frame of input data 502. When input data 502 is two-dimensional, absolute positional encoding 506 may be expressed as abs_grid∈ [symbol] . When input data 502 is three-dimensional, absolute positional encoding 506 may be expressed as abs_grid∈ [symbol] That is, absolute positional encodings 506 may include N vectors each having at least a number of values that corresponds to a dimensionality of input data 502.

Each respective feature vector of feature vectors 504 may be associated with a corresponding absolute positional encoding of absolute positional encodings 506. For example, abs_gridᵢ may represent a position of inputsᵢ in the reference frame of input data 502. For example, when input data 502 corresponds to an image, and feature vectors 504 thus represent visual features of the image, each respective absolute positional encoding of absolute positional encodings 506 may represent a position of one or more pixels of the image that are represented by a corresponding feature vector of feature vectors 504.

Slot vectors 524 may represent slot vectors 322-324 of FIG. 3. Slot vectors 524 may be expressed as slots∈ [symbol] . That is, slots vectors 524 may include K vectors each having Dₛₗₒₜₛ values. Output matrix Y, as discussed in connection with FIG. 3, may correspond to slots (e.g., slots=Y).

Entity-centric position vectors 532 may represent a position of each respective slot vector of slot vectors 524 in the reference frame of input data 502. When input data 502 is two-dimensional, entity-centric position vectors 532 may be expressed as S_{P}∈ [symbol] . When input data 502 is three-dimensional, entity-centric position vectors 532 may be expressed as S_{P}∈ [symbol] . Thus entity-centric position vectors 532 may include K entity-centric position vectors each having at least a number of values that corresponds to a dimensionality of input data 502 (and may include more values to provide a redundant position representation).

Each respective slot vector of slot vectors 524 may be associated with a corresponding entity-centric position vector of entity-centric position vectors 532. For example, S_{P}^{j} may represent a position of slots^{j} in the reference frame of input data 502. For example, each respective entity-centric position vector of entity-centric position vectors 532 may represent the position (e.g., the center of mass) of an entity that is represented by a corresponding slot vector of slot vectors 524.

Entity-centric scale vectors 528 may represent a scale of each respective slot vector of slot vectors 524 in the reference frame of input data 502. When input data 502 is two-dimensional, entity-centric scale vectors 528 may be expressed as S_{S}∈ [symbol] . When input data 502 is three-dimensional, entity-centric scale vectors 528 may be expressed as S_{S}∈ [symbol] Thus, entity-centric scale vectors 528 may include K entity-centric scale vectors each having at least a number of values that corresponds to a dimensionality of input data 502 (and may include more values to provide a redundant scale representation).

Each respective slot vector of slot vectors 524 may be associated with a corresponding entity-centric scale vector of entity-centric scale vectors 528. For example, S_{S}^{j} may represent a scale of slots^{j} in the reference frame of input data 502. For example, each respective entity-centric scale vector of entity-centric scale vectors 528 may represent the size (e.g., a spread, or area occupied by) of an entity that is represented by a corresponding slot vector of slot vectors 524.

Relative positional encoding calculator 508 may be configured to determine relative positional encodings 510 based on absolute positional encodings 506, entity-centric position vectors 532, and/or entity-centric scale vectors 528. Relative positional encodings 510 may be expressed as rel_grid∈ [symbol] . Relative positional encoding calculator 508 may implement the function

$$∀ k ϵ \{ 1 , … , K \} {rel\_grid}^{k} = ( abs\_grid - {S}_{P}^{k} ) / {S}_{S}^{k} .$$

Thus relative positional encodings 510 may be expressed as a matrix having N rows and K columns, with each element thereof having two values (i.e., a depth of 2).

Specifically, for each respective absolute positional encoding of absolute positional encodings 506 (i.e., ∀n∈{1, . . . , N}abs_gridⁿ), relative positional encoding calculator 508 may be configured to subtract each respective entity-centric position vector of entity-centric position vectors 532 from the respective absolute positional encoding, thereby determining K difference values per absolute positional encoding

$$( i . e . , ∀ k ϵ \{ 1 , … , K \} {Diff}^{k} = {abs\_grid}^{n} - {S}_{P}^{k} ) .$$

Relative positional encoding calculator 508 may also be configured to, for each respective absolute positional encoding of absolute positional encodings 506, divide each of the K difference values by a corresponding entity-centric scale vector of entity-centric scale vectors 528, thereby determining K quotient values per absolute positional encoding (i.e.,

$$( i . e . , ∀ k ϵ \{ 1 , … , K \} {Quotient}^{k} = {Diff}^{k} / {S}_{S}^{k} ) .$$

In implementations where scale is considered, but position is omitted, relative positional encoding calculator 508 may be configured to, for each respective absolute positional encoding of absolute positional encodings 506, divide the respective absolute positional encoding by each respective entity-centric scale vector of entity-centric scale vectors 528, thereby determining K quotient values per absolute positional encoding

$$( i . e . , ∀ k ϵ \{ 1 , … , K \} {Quotient}^{k *} = {abs\_grid}^{n} / {S}_{S}^{k} ) .$$

Thus, entity-centric position vectors 532 and/or entity-centric scale vectors 528 may be broadcast to each of absolute positional encodings 506.

Relative positional encoding calculator 508 may thus operate to center and/or scale feature vectors 504 into a respective reference frame of each of slot vectors 524, which may provide spatial symmetry under translation and/or scaling, respectively. Specifically, for a given slot vector of slot vectors 524, determining Diff^{k} may operate to center feature vectors 504 in the respective reference frame of the given slot vector, and determining Quotient^{k} (or Quotient^{k*}) may operate to scale (i.e., resize) feature vectors 504 to the respective reference frame of the given slot vector.

Accordingly, due to entity-centric position vectors 532 and entity-centric scale vectors 528 explicitly representing entity positions and scales, respectively, slot vectors 524 may be configured to represent entity attributes independently of positions and scales. Thus, two instances of the same entity (e.g., two instances of the same object in an image), each located at a different position within input data 502 and/or having a different size within input data 502, may each be represented using respective slot vectors that are substantially and/or approximately equal (i.e., very similar). That is, entity attributes, as represented by slot vectors 524, may be disentangled from entity positions and scales, as separately represented by entity-centric position vectors 532 and entity-centric scale vectors 528, respectively. By determining relative positional encodings 510, each respective slot vector of slot vectors 524 may perceive feature vectors 504 relative to itself, thus allowing the respective slot vector to represent attributes of the corresponding entity associated with and/or represented by the respective slot independently of the entity's position and size/scale.

Key/value matrix calculator 512 may be configured to generate key matrix 522 (analogous to key input matrix X_{KEY}, as discussed with respect to FIG. 3) and value matrix 520 (analogous to value input matrix X_{VALUE}, as discussed with respect to FIG. 3) based on feature vectors 504 and relative positional encodings 510. Specifically, key/value matrix calculator may implement the functions ∀k∈{1, . . . , K} keys^{k}=ƒ(k(inputs)+g(rel_grid^{k})) and ∀k∈{1, . . . , K} values^{k}=ƒ(v(inputs)+g(rel_grid^{k})). Key matrix 522 may be represented as keys∈ [symbol] , and value matrix 520 may be represented as values∈ [symbol] . Thus, each of key matrix 522 and value matrix 520 may include N rows and K columns, with each element thereof having D values (i.e., a depth of D).

Key function 310 represents and/or implements k( ), and thus k(inputs)∈ [symbol] (where k (inputs) corresponds to X_{KEY}, as discussed with respect to FIG. 3) represents feature vectors 504 transformed by key function 310 (alternatively referred to as key-transformed feature vectors). The key-transformed feature vectors may include N vectors each having D values. Value function 308 represents v( ), and thus v(inputs)∈ [symbol] (where v(inputs) corresponds to X_{VALUE}, as discussed with respect to FIG. 3) represents feature vectors 504 transformed by value function 308 (alternatively referred to as value-transformed feature vectors). The value-transformed feature vectors may include N vectors each having D values.

Position function 514 represents g( ), and thus g(rel_grid)∈ [symbol] represents relative positional encodings 510 transformed by position function 514 [symbol] (alternatively referred to as position-transformed relative positional encodings). Position function 514 may represent a learned/trained function, which may include linear and/or non-linear terms. The term “position” is used in connection with position function 514 as a way to differentiate function 514 (i.e., g( )) from other learned/trained functions discussed herein. The position-transformed relative positional encodings may be represented as a matrix having N rows and K columns, with each element thereof having D values.

Broadcast adders 516 and 518 may represent the broadcasted addition of g(rel_grid^{k}) to k(inputs) and v(inputs), respectively. Specifically, for each respective key-transformed feature vector of k(inputs) (i.e., ∀n∈{1, . . . , N}k(inputs)ⁿ), broadcast adder 518 of key/value matrix calculator 512 may be configured to add each respective position-transformed relative positional encodings of g(rel_grid^{k}) to the respective key-transformed feature vector, thereby determining K sum values per key-transformed feature vector

$$( i . e . , ∀ k ϵ \{ 1 , … , K \} {Sum}_{k e y}^{k} = {k ( inputs )}^{n} + g ( {rel\_grid}^{k} ) .$$

Similarly, for each respective value-transformed feature vector of v(inputs) (i.e., ∀n∈{1, . . . , N} v(inputs)ⁿ), broadcast adder 518 of key/value matrix calculator 512 may be configured to add each respective position-transformed relative positional encodings of g(rel_grid^{k}) to the respective value-transformed feature vector, thereby determining K sum values per value-transformed feature vector

$$( i . e . , ∀ k ϵ \{ 1 , … , K \} {Sum}_{value}^{k} = {k ( inputs )}^{n} + g ( {rel\_grid}^{k} ) .$$

Thus, position-transformed relative positional encodings g(rel_grid) may be broadcast to each of the key-transformed feature vectors and the value-transformed feature vectors.

Key/value matrix calculator 512 may also be configured to apply, to each of

$${Sum}_{key}^{k} and {Sum}_{value}^{k} ,$$

function ƒ( ), which may represent a learned/trained function that may include linear and/or non-linear terms. The function ƒ( ) may be referred to as final function ƒ( ), and the term “final” may be used in connection with this function as a way to differentiate it from other leamed/trained functions discussed herein. Function ƒ( ) may provide a learned/trained mapping of each of

$${Sum}_{key}^{k} and {Sum}_{value}^{k}$$

to key matrix 522 and value matrix 520, respectively, and this mapping may or might not affect the dimensionality from input to output (dimensionality is assumed to be unchanged in the example provided).

Query function 312 may include a linear and/or non-linear transformation of slot vectors 524, and may be expressed as q( ), the output of which may be a query-transformed slot matrix (representing K query-transformed slot vectors 524) that includes K rows and D columns. Specifically, q(slots)∈ [symbol] , where q(slots) corresponds to Y_{QUERY}, as discussed with respect to FIG. 3, and represents slot vectors 524 transformed by query function 312.

Slot attention calculator 314 may be configured to determine attention matrix 340 based on key matrix 522 and the query-transformed slot vectors determined by query function 312. Attention matrix 340 may be expressed as attn∈ [symbol] , where attn=A, as discussed with respect to FIG. 3. Slot attention calculator 314 may implement the function

$$attn = softmax ( \frac{1}{\sqrt{K}} keys * {q ( slots )}^{T} , axis = slots ) ,$$

where the K×D query-transformed slot matrix (and thus each respective query-transformed slot vector of the K query-transformed slot vectors represented thereby) is broadcast to each of the N vectors (having dimension K×D) that form key matrix 522, thereby determining NxK dot products. In some implementations (e.g., as discussed with respect to FIG. 3), the term

$$\frac{1}{\sqrt{K}}$$

may be replaced by

$$\frac{1}{\sqrt{D}} .$$

Since attention matrix 340 is based on key matrix 522, it may reflect the extent to which each slot attends to different possible offsets and scales (as represented by relative positional encodings 510) of feature vectors 504.

Slot update calculator 316 may be configured to determine update matrix 342 based on value matrix 520 and attention matrix 340. Update matrix 342 may be expressed as updates∈ [symbol] , where updates corresponds to U_{WEIGHTED SUM} and/or U_{WEIGHTED MEAN}, as discussed with respect to FIG. 3. Slot update calculator 316 may implement the function updates=WeightedMean(weights=attn, values=values). Since update matrix 342 is based on attention matrix 340 and value matrix 520, update matrix 342 may also reflect the extent to which each slot attends to different possible offsets and scales (as represented by relative positional encodings 510) of feature vectors 504.

Entity-centric position vector calculator 530 may be configured to determine entity-centric position vectors 532 based on attention matrix 340 and absolute positional encodings 506. Specifically, entity-centric position vector calculator 530 may implement the function S_{P}=WeightedMean(weights=attn, values=abs_grid), which may be alternatively expressed as

$$∀ k ϵ \{ 1 , … , K \} {S}_{P}^{k} = {\sum }_{n} {attn}_{n , k} * {abs\_grid}_{n} / {\sum }_{n} {attn}_{n , k} ,$$

where

$${S}_{P}^{k}$$

represents the kth entity-centric position vector corresponding to the kth slot vector, and attn_{n,k} represents the element of attention matrix 340 in row n and column k. Thus, entity-centric position vector calculator 530 may determine a weighted mean, where the weights are corresponding elements of attention matrix 340, and the values are absolute positional encodings 506. Accordingly, the corresponding entity-centric position vector of a respective slot vector may represent a center of mass of the respective slot vector within attention matrix 340.

Entity-centric scale vector calculator 526 may be configured to determine entity-centric scale vectors 528 based on attention matrix 340, absolute positional encodings 506, and entity-centric position vectors 532. Specifically, entity-centric position vector calculator 530 may implement the function S_{S}=WeightedMean(weights=attn+∈, values=(abs_grid−S_{P})²), which may be alternatively expressed as

$$∀ k ϵ \{ 1 , … , K \} {S}_{S}^{k} = {\sum }_{n} ( {attn}_{n , k} + ϵ ) * {( {abs\_grid}_{n} - {S}_{P}^{k} )}^{2} / {\sum }_{n} ( {attn}_{n , k} + ϵ ) ,$$

where

$${S}_{S}^{k}$$

represents the kth entity-centric scale vector corresponding to the kth slot vector. Thus, entity-centric scale vector calculator 526 may determine a weighted mean, where the weights are corresponding elements of attention matrix 340 with the addition of a small predetermined offset value e, and the values are squares of differences between (i) absolute positional encodings 506 and (ii) entity-centric position vectors 532. Accordingly, the corresponding entity-centric scale vector of a respective slot vector may represent a spread of (e.g., an area occupied by) the respective slot vector within attention matrix 340.

Equivariant slot attention model 500 may operate iteratively, with slot vectors 524, entity-centric position vectors 532, and/or entity-centric scale vectors 528 being updated at each iteration, and eventually converging to respective final values. Vector initializer 534 may be configured to initialize each of slot vectors 524, entity-centric position vectors 532, and/or entity-centric scale vectors 528 prior to a first iteration, or pass-through, of equivariant slot attention model 500. Vector initializer 534 may include slot vector initializer 318 configured to initialize each of slot vectors 524, as discussed with respect to FIG. 3.

In one example, vector initializer 534 may be configured to initialize each of entity-centric position vectors 532 and entity-centric scale vectors 528 with random values (e.g., substantially and/or approximately random values) selected, for example, from a normal (i.e., Gaussian) distribution. In other examples, vector initializer 534 may be configured to initialize one or more respective vectors of entity-centric position vectors 532 and/or entity-centric scale vectors 528 with “seed” values configured to cause the one or more respective vectors to attend/bind to, and thereby represent, a particular entity contained within input data 502. For example, when processing image frames of a video, vector initializer 534 may be configured to initialize entity-centric position vectors 532 and/or entity-centric scale vectors for a second image frame based on the values of entity-centric position vectors 532 and/or entity-centric scale vectors 528 determined with respect to a first image frame that precedes the second image frame. Accordingly, a particular slot vector of slot vectors 524, and its corresponding position and scale vectors, may be caused to represent the same entity across image frames of the video. Other types of sequential data may be similarly seeded by vector initializer 534.

At each respective iteration of equivariant slot attention model 500 aside from a first iteration, entity-centric position vectors 532 and/or entity-centric scale vectors 528 may be determined based on values of slot vectors 524 determined as part of an immediately-preceding iteration of equivariant slot attention model. At the first iteration of equivariant slot attention model 500, entity-centric position vectors 532 and/or entity-centric scale vectors 528 may be determined based on the initial values of slot vectors 524 determined by vector initializer 534. Accordingly, a final set of values of slot vectors 524 may be determined as part of a penultimate iteration (e.g., the (Z−1)th iteration of Z iterations) of equivariant slot attention model 500, while a final set of values of entity-centric position vectors 532 and/or entity-centric scale vectors 528 may be determined as part of an ultimate iteration (e.g., the Zth iteration of Z iterations) of equivariant slot attention model 500. A further set of values of slot vectors 524 might not be determined as part of the ultimate iteration of equivariant slot attention model 500, resulting in the values of entity-centric position vectors 532 and/or entity-centric scale vectors 528 being determined based on, and thus corresponding to, the final set of values of slot vectors 524.

While FIG. 5 provides an example of how translation and/or scale equivariance can be added to a model configured to determine slot vectors, such translation and/or scale equivariance can additionally and/or alternatively be added to other models that determine entity-centric latent representations in other ways. That is, slot vectors 524 are provided herein as one example of entity-centric latent representations that could be augmented with translation and scale equivariance. For example, relative positional encoding calculator 508, entity-centric scale vector calculator 526, and entity-centric position vector calculator 530 may be added to other attention-based model architectures that process feature vectors 504 in other ways (e.g., using transformer-based architectures) to determine entity-centric latent representations.

### VI. EXAMPLE ADJUSTMENTS TO ENTITY-CENTRIC POSITION AND SCALE VECTORS

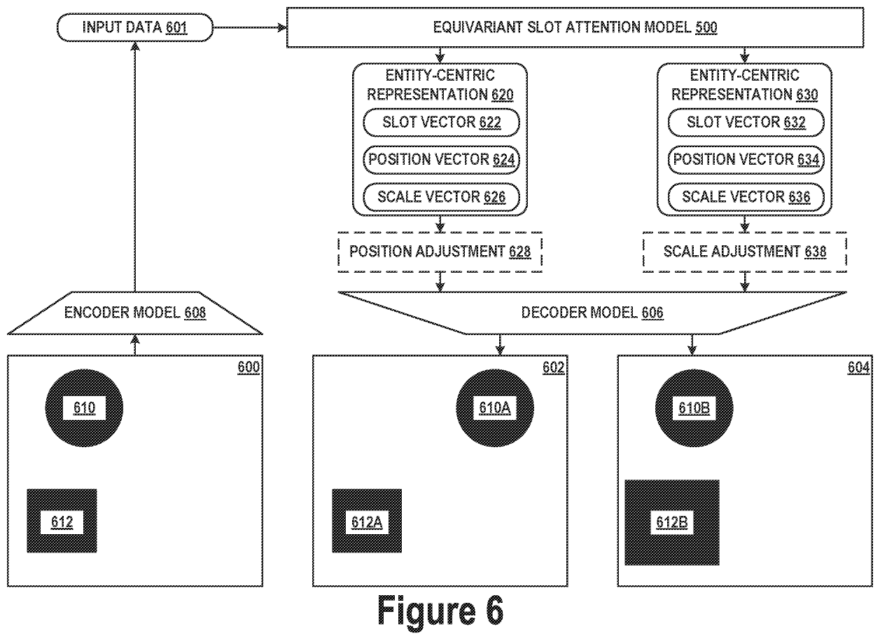

FIG. 6 graphically illustrates the effects of adjustments to entity-centric position vectors and entity-centric scale vectors. Input data 601, which represents input data 502, may be determined by processing image 600 by encoder model 608, which may be configured to generate the feature vectors. The absolute positional encodings may be generated by encoder model 608 and/or a predetermined algorithm. Image 600 (which may be an analogue/variation of image 400) includes two entities: entity 610 (i.e., a circular object) and entity 612 (i.e., a square object).

Input data 601 may be processed by one or more iterations of equivariant slot attention model 500 to generate entity-centric representation 620 of entity 610 and entity-centric representation 630 of entity 612. Entity-centric representation 620 may include slot vector 622 representing attributes of entity 610, (entity-centric) position vector 624 representing a position of entity 610 within image 600, and (entity-centric) scale vector 626 representing a size/scale of entity 610 within image 600. Entity-centric representation 630 may include slot vector 632 representing attributes of entity 612, (entity-centric) position vector 634 representing a position of entity 612 within image 600, and (entity-centric) scale vector 636 representing a size/scale of entity 612 within image 600.

Values of position vector 624 and/or scale vector 626 may be adjustable to control a position and/or size/scale, respectively, of entity 610 within a reconstruction of image 600. Values of position vector 634 and/or scale vector 636 may be adjustable to control a position and/or size/scale, respectively, of entity 612 within reconstructions of image 600.

In one example, a value of position vector 624 corresponding to a width of image 600 (e.g., the x-coordinate of position vector 624) may be increased, as indicated by position adjustment 628. As a result of position adjustment 628, image 602 generated by decoder model 606 based on entity-centric representation 620 (and an unmodified version of entity-centric representation 630) may include entity 610A translated to the right relative to the position of entity 610 in image 600 (and entity 612A in an unmodified position relative to the position of entity 612 in image 600). A value of position vector 624 corresponding to a height of image 600 (e.g., the y-coordinate of position vector 624) may be similarly adjusted. Position vector 634 may also be similarly adjusted to control a position of entity 612A in image 602 and/or entity 612B in image 604.

In another example, values of scale vector 636 (along both the width and height of image 600) corresponding to an area of image 600 occupied by entity 612 may be increased, as indicated by scale adjustment 638. As a result of scale adjustment 638, image 604 generated by decoder model 606 based on entity-centric representation 630 (and an unmodified version of entity-centric representation 620) may include entity 612B of a greater size/scale relative to the size/scale of entity 612 in image 600 (and entity 610B of the same size as entity 610 in image 600). A value of scale vector 636 corresponding to the width of image 600 (e.g., the x-axis value of scale vector 636) may be adjusted independently of a value of scale vector 636 corresponding to the height of image 600 (e.g., the y-axis value of scale vector 636), thus causing entity 612B to stretch horizontally relative to entity 612. Additionally, the value of scale vector 636 corresponding to the height of image 600 may be adjusted independently of the value of scale vector 636 corresponding to the width of image 600, thus causing entity 612B to stretch vertically relative to entity 612. Scale vector 626 may also be similarly adjusted to control a size/scale of entity 610A in image 602 and/or entity 610B in image 604.

Regardless of how position vectors 624 and 634 and scale vectors 626 and 636 are modified, as long as slot vectors 622 and 632 are unmodified, the appearance of entities 610A and 610B (aside from position and scale) may be approximately and/or substantially the same as that of entity 610, the appearance of entities 612A and 612B (aside from position and scale) may be approximately the same as that of entity 612. That is, object position and scale in reconstructions by decoder model 606 may be controlled independently of object attributes, thus making slot vectors 622 and 632 equivariant with respect to translation and scaling.

### VII. ADDITIONAL EXAMPLE OPERATIONS

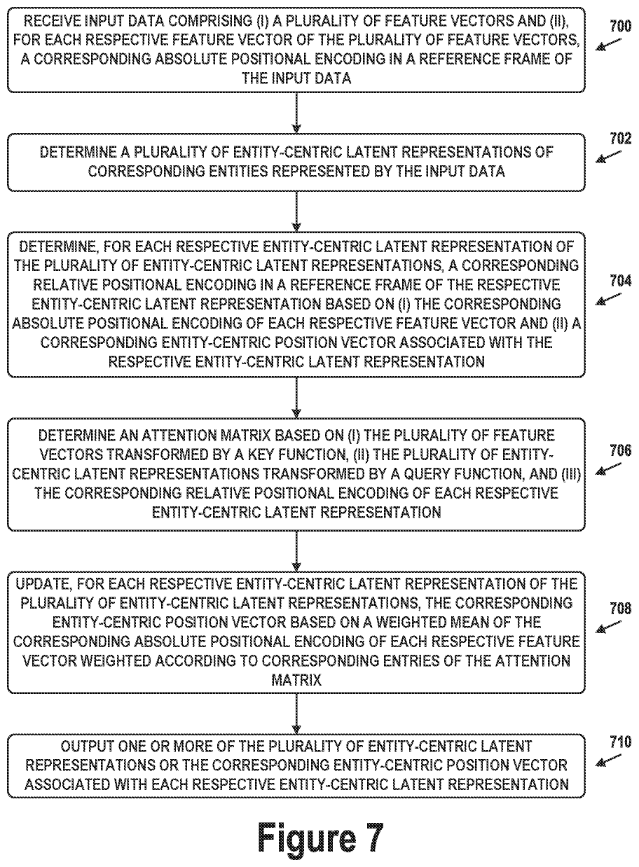

FIG. 7 illustrates a flow chart of operations related to determining position and scale equivariant entity-centric latent representations. The operations may be carried out by computing system 100, computing device 200, slot attention model 300, and/or equivariant slot attention model 500, among other possibilities. The embodiments of FIG. 7 may be simplified by the removal of any one or more of the features shown therein. Further, these embodiments may be combined with features, aspects, and/or implementations of any of the previous figures or otherwise described herein.

Block 700 may involve receiving input data that includes (i) a plurality of feature vectors and (ii), for each respective feature vector of the plurality of feature vectors, a corresponding absolute positional encoding in a reference frame of the input data.

Block 702 may involve determining a plurality of entity-centric latent representations of corresponding entities represented by the input data.

Block 704 may involve determining, for each respective entity-centric latent representation of the plurality of entity-centric latent representations, a corresponding relative positional encoding in a reference frame of the respective entity-centric latent representation based on (i) the corresponding absolute positional encoding of each respective feature vector and (ii) a corresponding entity-centric position vector associated with the respective entity-centric latent representation.

Block 706 may involve determining an attention matrix based on (i) the plurality of feature vectors transformed by a key function, (ii) the plurality of entity-centric latent representations transformed by a query function, and (iii) the corresponding relative positional encoding of each respective entity-centric latent representation.

Block 708 may involve updating, for each respective entity-centric latent representation of the plurality of entity-centric latent representations, the corresponding entity-centric position vector based on a weighted mean of the corresponding absolute positional encoding of each respective feature vector weighted according to corresponding entries of the attention matrix.

For example, the entity-centric position vectors may be expressed as

$${S}_{P} = WeightedMean ( weights = attn , values = abs\_grid ) ,$$

$$or as ,$$

$${S}_{P}^{k} = {\sum }_{n} {attn}_{n , k} * {abs\_grid}_{n} / {\sum }_{n} {attn}_{n , k} .$$

Block 710 may involve outputting one or more of the plurality of entity-centric latent representations or the corresponding entity-centric position vector associated with each respective entity-centric latent representation.

In some embodiments, determining the corresponding relative positional encoding may include determining a first plurality of difference values between (i) the corresponding absolute positional encoding of each respective feature vector and (ii) the corresponding entity-centric position vector associated with each respective entity-centric latent representation. For example, the first plurality of difference values may be expressed as ∀k∈{1, . . . , K},

$$( abs\_grid - {S}_{P}^{k} ) .$$

Determining the first plurality of difference values may operate to center the plurality of feature vectors relative to the reference frame of the respective entity-centric latent representation. The corresponding entity-centric position vector may represent a center of mass of the respective entity-centric latent representation in the attention matrix.

In some embodiments, the corresponding relative positional encoding may be determined, for each respective entity-centric latent representation of the plurality of entity-centric latent representations, further based on a corresponding entity-centric scale vector associated with the respective entity-centric latent representation. The corresponding entity-centric scale vector may be updated, for each respective entity-centric latent representation of the plurality of entity-centric latent representations, based on a weighted mean of (i) a second plurality of difference values between the corresponding absolute positional encoding of each respective feature vector and the corresponding entity-centric position vector of each respective entity-centric latent representation weighted according to (ii) a corresponding entry of the attention matrix. The corresponding entity-centric scale vector associated with each respective entity-centric latent representation may be generated as output.

In some embodiments, the corresponding entity-centric scale vector may be based on a weighted mean of a square of the second plurality of difference values weighted according to a sum of (i) the corresponding entry of the attention matrix and (ii) a predetermined offset value that is smaller than a predetermined threshold value. For example, the entity-centric scale vectors may be expressed as

$${S}_{S} = WeightedMean ( weights = attn + ϵ , values = {( abs\_grid - {S}_{P} )}^{2} ) ,$$

$$or$$

$${S}_{S}^{k} = {\sum }_{n} ( {attn}_{n , k} + ϵ ) * {( {abs\_grid}_{n} - {S}_{P}^{k} )}^{2} / {\sum }_{n} ( {attn}_{n , k} + ϵ ) .$$

In some embodiments, determining the corresponding relative positional encoding may include determining a plurality of quotients based on (i) the corresponding absolute positional encoding of each respective feature vector and (ii) the corresponding entity-centric scale vector associated with each respective entity-centric latent representation. For example, the plurality of quotients values may be expressed as ∀k∈{1, . . . , K},

$$( abs\_grid ) / {S}_{S}^{k}$$

when adjusting for scale, or ∀k∈{1, . . . , K},

$$( abs\_grid - {S}_{P}^{k} ) / {S}_{S}^{k}$$

when adjusting for both position and scale. Determining the plurality of quotients may operate to scale the plurality of feature vectors relative to the reference frame of the respective entity-centric latent representation. The corresponding entity-centric scale vector may represent a spatial spread of the respective entity-centric latent representation in the attention matrix.

In some embodiments, the corresponding entity-centric position vector associated with the respective entity-centric latent representation may provide a translation equivariant representation of a corresponding entity represented by the input data. The corresponding entity-centric scale vector associated with the respective entity-centric latent representation may provide a scale equivariant representation of the corresponding entity.

In some embodiments, before generating output data based on the plurality of entity-centric latent representations, an adjustment may be made to one or more of: (i) a value of the corresponding entity-centric position vector associated with the respective entity-centric latent representation to modify a position of the corresponding entity within the output data or (ii) a value of the corresponding entity-centric scale vector associated with the respective entity-centric latent representation to modify a size of the corresponding entity within the output data.

In some embodiments, determining the attention matrix may include determining, for each respective key-transformed feature vector of the plurality of feature vectors transformed by the key function, a first corresponding plurality of sums of (i) the respective key-transformed feature vector and (ii) the corresponding relative positional encoding of each respective entity-centric latent representation transformed by a position function. Determining the attention matrix may also include determining a key matrix by transforming the first corresponding plurality of sums, and determining a product of (i) the key matrix and (ii) the plurality of entity-centric latent representations transformed by the query function. For example, the key matrix may be expressed as ∀k∈{1, . . . , K} keys^{k}=ƒ(k(inputs)+g(rel_grid^{k})).

In some embodiments, determining the attention matrix may further include applying a softmax function to the product along a dimension corresponding to the plurality of entity-centric latent representations.

In some embodiments, an update matrix may be determined based on (i) the plurality of feature vectors transformed by a value function, (ii) the attention matrix, and (iii) the corresponding relative positional encoding of each respective entity-centric latent representation. The plurality of entity-centric latent representations may be updated based on the update matrix by way of a neural network memory unit configured to represent the plurality of entity-centric latent representations.

In some embodiments, determining the update matrix may include determining, for each respective value-transformed feature vector of the plurality of feature vectors transformed by the value function, a second corresponding plurality of sums of (i) the respective value-transformed feature vector and (ii) the corresponding relative positional encoding of each respective entity-centric latent representation transformed by a position function. Determining the update matrix may also include determining a value matrix by transforming the second corresponding plurality of sums, and determining a weighted mean of respective values of the value matrix weighted according to corresponding entries of the attention matrix. For example, the value matrix may be expressed as ∀k∈{1, . . . , K} values^{k}=ƒ(v(inputs)+g(rel_grid^{k})).

In some embodiments, for each respective iteration of a plurality of iterations comprising N iterations, a corresponding instance may be determined of each of (i) the plurality of entity-centric latent representations, (ii) the corresponding relative positional encoding of each respective entity-centric latent representation, (iii) the corresponding entity-centric position vector of each respective entity-centric latent representation, and (iv) the attention matrix. For the respective iteration, the plurality of entity-centric latent representations may be based on a preceding plurality of entity-centric latent representations determined during a preceding iteration of the plurality of iterations. For the respective iteration, the corresponding relative positional encoding may be based on the corresponding entity-centric position vector determined during the preceding iteration. For the respective iteration, the attention matrix may be based on the preceding plurality of entity-centric latent representations determined during the preceding iteration. For the respective iteration, the corresponding entity-centric position vector may be based on the attention matrix determined during the respective iteration. During the plurality of iterations, the corresponding entity-centric position vector may be determined N times, and the plurality of entity-centric latent representations may be determined N−1 times.

In some embodiments, for each respective iteration of a plurality of iterations, a corresponding instance may be determined of the corresponding entity-centric scale vector of each respective entity-centric latent representation. For the respective iteration, the corresponding relative positional encoding may be further based on the corresponding entity-centric scale vector determined during the preceding iteration, and the corresponding entity-centric scale vector may be based on the attention matrix determined during the respective iteration.

In some embodiments, during a first iteration of the plurality of iterations, the corresponding instance of each of (i) the plurality of entity-centric latent representations and (ii) the corresponding entity-centric position vector may be initialized using substantially random values.

In some embodiments, during the first iteration of the plurality of iterations, the corresponding instance of the corresponding entity-centric scale vector may be initialized using substantially random values.

In some embodiments, output data may be determined using a decoder model based on (i) the plurality of entity-centric latent representations and (ii) the corresponding entity-centric position vector associated with each respective entity-centric latent representation of the plurality of entity-centric latent representations.

In some embodiments, the output data may be determined using the decoder model further based on the corresponding entity-centric scale vector associated with each respective entity-centric latent representation of the plurality of entity-centric latent representations.

In some embodiments, determining the output data may include determining, for each respective entity-centric latent representation of the plurality of entity-centric latent representations, a corresponding decoded relative positional encoding based on (i) the corresponding absolute positional encoding of each respective feature vector and (ii) the corresponding entity-centric position vector associated with the respective entity-centric latent representation. Determining the output data may also include determining, using the decoder model, the output data based on the corresponding decoded relative positional encoding of each respective entity-centric latent representation of the plurality of entity-centric latent representations.

In some embodiments, the corresponding decoded relative positional encoding may be determined further based on the corresponding entity-centric scale vector associated with the respective entity-centric latent representation.

In some embodiments, the plurality of feature vectors may represent contents of sensor data generated by a sensor based on a physical environment.

In some embodiments, the plurality of feature vectors may represent contents of an image having a width and a height. Each of the corresponding relative positional encoding and the corresponding entity-centric position vector may include a first value representing a position along the width and a second value representing a position along the height.

In some embodiments, the plurality of feature vectors may represent contents of a three-dimensional map having a width, a height, and a depth. Each of the corresponding relative positional encoding and the corresponding entity-centric position vector may include a first value representing a position along the width, a second value representing a position along the height, and a third value representing a position along a depth.

### VII. CONCLUSION

The present disclosure is not to be limited in terms of the particular embodiments described in this application, which are intended as illustrations of various aspects. Many modifications and variations can be made without departing from its scope, as will be apparent to those skilled in the art. Functionally equivalent methods and apparatuses within the scope of the disclosure, in addition to those described herein, will be apparent to those skilled in the art from the foregoing descriptions. Such modifications and variations are intended to fall within the scope of the appended claims.

The above detailed description describes various features and operations of the disclosed systems, devices, and methods with reference to the accompanying figures. In the figures, similar symbols typically identify similar components, unless context dictates otherwise. The example embodiments described herein and in the figures are not meant to be limiting. Other embodiments can be utilized, and other changes can be made, without departing from the scope of the subject matter presented herein. It will be readily understood that the aspects of the present disclosure, as generally described herein, and illustrated in the figures, can be arranged, substituted, combined, separated, and designed in a wide variety of different configurations.

With respect to any or all of the message flow diagrams, scenarios, and flow charts in the figures and as discussed herein, each step, block, and/or communication can represent a processing of information and/or a transmission of information in accordance with example embodiments. Alternative embodiments are included within the scope of these example embodiments. In these alternative embodiments, for example, operations described as steps, blocks, transmissions, communications, requests, responses, and/or messages can be executed out of order from that shown or discussed, including substantially concurrently or in reverse order, depending on the functionality involved. Further, more or fewer blocks and/or operations can be used with any of the message flow diagrams, scenarios, and flow charts discussed herein, and these message flow diagrams, scenarios, and flow charts can be combined with one another, in part or in whole.

A step or block that represents a processing of information may correspond to circuitry that can be configured to perform the specific logical functions of a herein-described method or technique. Alternatively or additionally, a block that represents a processing of information may correspond to a module, a segment, or a portion of program code (including related data). The program code may include one or more instructions executable by a processor for implementing specific logical operations or actions in the method or technique. The program code and/or related data may be stored on any type of computer readable medium such as a storage device including random access memory (RAM), a disk drive, a solid state drive, or another storage medium.

The computer readable medium may also include non-transitory computer readable media such as computer readable media that store data for short periods of time like register memory, processor cache, and RAM. The computer readable media may also include non-transitory computer readable media that store program code and/or data for longer periods of time. Thus, the computer readable media may include secondary or persistent long term storage, like read only memory (ROM), optical or magnetic disks, solid state drives, compact-disc read only memory (CD-ROM), for example. The computer readable media may also be any other volatile or non-volatile storage systems. A computer readable medium may be considered a computer readable storage medium, for example, or a tangible storage device.

Moreover, a step or block that represents one or more information transmissions may correspond to information transmissions between software and/or hardware modules in the same physical device. However, other information transmissions may be between software modules and/or hardware modules in different physical devices.

The particular arrangements shown in the figures should not be viewed as limiting. It should be understood that other embodiments can include more or less of each element shown in a given figure. Further, some of the illustrated elements can be combined or omitted. Yet further, an example embodiment can include elements that are not illustrated in the figures.

While various aspects and embodiments have been disclosed herein, other aspects and embodiments will be apparent to those skilled in the art. The various aspects and embodiments disclosed herein are for purpose of illustration and are not intended to be limiting, with the true scope being indicated by the following claims.

1. A computer-implemented method comprising:
receiving input data comprising (i) a plurality of feature vectors and (ii), for each respective feature vector of the plurality of feature vectors, a corresponding absolute positional encoding in a reference frame of the input data;
determining a plurality of entity-centric latent representations of corresponding entities represented by the input data;
determining, for each respective entity-centric latent representation of the plurality of entity-centric latent representations, a corresponding relative positional encoding in a reference frame of the respective entity-centric latent representation based on (i) the corresponding absolute positional encoding of each respective feature vector and (ii) a corresponding entity-centric position vector associated with the respective entity-centric latent representation;
determining an attention matrix based on (i) the plurality of feature vectors transformed by a key function, (ii) the plurality of entity-centric latent representations transformed by a query function, and (iii) the corresponding relative positional encoding of each respective entity-centric latent representation;
updating, for each respective entity-centric latent representation of the plurality of entity-centric latent representations, the corresponding entity-centric position vector based on a weighted mean of the corresponding absolute positional encoding of each respective feature vector weighted according to corresponding entries of the attention matrix; and
outputting one or more of the plurality of entity-centric latent representations or the corresponding entity-centric position vector associated with each respective entity-centric latent representation.

2. The computer-implemented method of claim 1, wherein determining the corresponding relative positional encoding comprises:
determining a first plurality of difference values between (i) the corresponding absolute positional encoding of each respective feature vector and (ii) the corresponding entity-centric position vector associated with each respective entity-centric latent representation, wherein determining the first plurality of difference values operates to center the plurality of feature vectors relative to the reference frame of the respective entity-centric latent representation, and wherein the corresponding entity-centric position vector represents a center of mass of the respective entity-centric latent representation in the attention matrix.

3. The computer-implemented method of claim 1, further comprising:
determining, for each respective entity-centric latent representation of the plurality of entity-centric latent representations, the corresponding relative positional encoding further based on a corresponding entity-centric scale vector associated with the respective entity-centric latent representation;
updating, for each respective entity-centric latent representation of the plurality of entity-centric latent representations, the corresponding entity-centric scale vector based on a weighted mean of (i) a second plurality of difference values between the corresponding absolute positional encoding of each respective feature vector and the corresponding entity-centric position vector of each respective entity-centric latent representation weighted according to (ii) a corresponding entry of the attention matrix; and
outputting the corresponding entity-centric scale vector associated with each respective entity-centric latent representation.

4. The computer-implemented method of claim 3, wherein the corresponding entity-centric scale vector is based on a weighted mean of a square of the second plurality of difference values weighted according to a sum of (i) the corresponding entry of the attention matrix and (ii) a predetermined offset value that is smaller than a predetermined threshold value.

5. The computer-implemented method of claim 3, wherein determining the corresponding relative positional encoding comprises:
determining a plurality of quotients based on (i) the corresponding absolute positional encoding of each respective feature vector and (ii) the corresponding entity-centric scale vector associated with each respective entity-centric latent representation, wherein determining the plurality of quotients operates to scale the plurality of feature vectors relative to the reference frame of the respective entity-centric latent representation, and wherein the corresponding entity-centric scale vector represents a spatial spread of the respective entity-centric latent representation in the attention matrix.

6. The computer-implemented method of claim 3, wherein the corresponding entity-centric position vector associated with the respective entity-centric latent representation provides a translation equivariant representation of a corresponding entity represented by the input data, and wherein the corresponding entity-centric scale vector associated with the respective entity-centric latent representation provides a scale equivariant representation of the corresponding entity.

7. The computer-implemented method of claim 6, further comprising:
before generating output data based on the plurality of entity-centric latent representations, adjusting one or more of: (i) a value of the corresponding entity-centric position vector associated with the respective entity-centric latent representation to modify a position of the corresponding entity within the output data or (ii) a value of the corresponding entity-centric scale vector associated with the respective entity-centric latent representation to modify a size of the corresponding entity within the output data.

8. The computer-implemented method of claim 1, wherein determining the attention matrix comprises:
determining, for each respective key-transformed feature vector of the plurality of feature vectors transformed by the key function, a first corresponding plurality of sums of (i) the respective key-transformed feature vector and (ii) the corresponding relative positional encoding of each respective entity-centric latent representation transformed by a position function;
determining a key matrix by transforming the first corresponding plurality of sums; and
determining a product of (i) the key matrix and (ii) the plurality of entity-centric latent representations transformed by the query function.

9. The computer-implemented method of claim 8, wherein determining the attention matrix further comprises:
applying a softmax function to the product along a dimension corresponding to the plurality of entity-centric latent representations.

10. The computer-implemented method of claim 1, further comprising:
determining an update matrix based on (i) the plurality of feature vectors transformed by a value function, (ii) the attention matrix, and (iii) the corresponding relative positional encoding of each respective entity-centric latent representation; and
updating the plurality of entity-centric latent representations based on the update matrix by way of a neural network memory unit configured to represent the plurality of entity-centric latent representations.

11. The computer-implemented method of claim 10, wherein determining the update matrix comprises:
determining, for each respective value-transformed feature vector of the plurality of feature vectors transformed by the value function, a second corresponding plurality of sums of (i) the respective value-transformed feature vector and (ii) the corresponding relative positional encoding of each respective entity-centric latent representation transformed by a position function;
determining a value matrix by transforming the second corresponding plurality of sums; and
determining a weighted mean of respective values of the value matrix weighted according to corresponding entries of the attention matrix.

12. The computer-implemented method of claim 1, further comprising:
determining, for each respective iteration of a plurality of iterations comprising N iterations, a corresponding instance of each of (i) the plurality of entity-centric latent representations, (ii) the corresponding relative positional encoding of each respective entity-centric latent representation, (iii) the corresponding entity-centric position vector of each respective entity-centric latent representation, and (iv) the attention matrix, wherein, for the respective iteration:
the plurality of entity-centric latent representations is based on a preceding plurality of entity-centric latent representations determined during a preceding iteration of the plurality of iterations;
the corresponding relative positional encoding is based on the corresponding entity-centric position vector determined during the preceding iteration;
the attention matrix is based on the preceding plurality of entity-centric latent representations determined during the preceding iteration; and
the corresponding entity-centric position vector is based on the attention matrix determined during the respective iteration; and
wherein, during the plurality of iterations, the corresponding entity-centric position vector is determined N times, and the plurality of entity-centric latent representations is determined N−1 times.

13. The computer-implemented method of claim 12, wherein, during a first iteration of the plurality of iterations, the corresponding instance of each of (i) the plurality of entity-centric latent representations and (ii) the corresponding entity-centric position vector is initialized using substantially random values.

14. The computer-implemented method of claim 1, further comprising:
determining, using a decoder model and based on (i) the plurality of entity-centric latent representations and (ii) the corresponding entity-centric position vector associated with each respective entity-centric latent representation of the plurality of entity-centric latent representations, output data.

15. The computer-implemented method of claim 14, wherein determining the output data comprises:
determining, for each respective entity-centric latent representation of the plurality of entity-centric latent representations, a corresponding decoded relative positional encoding based on (i) the corresponding absolute positional encoding of each respective feature vector and (ii) the corresponding entity-centric position vector associated with the respective entity-centric latent representation; and
determining, using the decoder model, the output data based on the corresponding decoded relative positional encoding of each respective entity-centric latent representation of the plurality of entity-centric latent representations.

16. The computer-implemented method of claim 1, wherein the plurality of feature vectors represent contents of sensor data generated by a sensor based on a physical environment.

17. The computer-implemented method of claim 1, wherein the plurality of feature vectors represent contents of an image having a width and a height, and wherein each of the corresponding relative positional encoding and the corresponding entity-centric position vector comprises a first value representing a position along the width and a second value representing a position along the height.

18. The computer-implemented method of claim 1, wherein the plurality of feature vectors represent contents of a three-dimensional map having a width, a height, and a depth, and wherein each of the corresponding relative positional encoding and the corresponding entity-centric position vector comprises a first value representing a position along the width, a second value representing a position along the height, and a third value representing a position along a depth.

19. A system comprising:
a processor; and
a non-transitory computer-readable medium having stored thereon instructions that, when executed by the processor, cause the processor to perform operations comprising:
receiving input data comprising (i) a plurality of feature vectors and (ii), for each respective feature vector of the plurality of feature vectors, a corresponding absolute positional encoding in a reference frame of the input data;
determining a plurality of entity-centric latent representations of corresponding entities represented by the input data;
determining, for each respective entity-centric latent representation of the plurality of entity-centric latent representations, a corresponding relative positional encoding in a reference frame of the respective entity-centric latent representation based on (i) the corresponding absolute positional encoding of each respective feature vector and (ii) a corresponding entity-centric position vector associated with the respective entity-centric latent representation;
determining an attention matrix based on (i) the plurality of feature vectors transformed by a key function, (ii) the plurality of entity-centric latent representations transformed by a query function, and (iii) the corresponding relative positional encoding of each respective entity-centric latent representation;
updating, for each respective entity-centric latent representation of the plurality of entity-centric latent representations, the corresponding entity-centric position vector based on a weighted mean of the corresponding absolute positional encoding of each respective feature vector weighted according to corresponding entries of the attention matrix; and
outputting one or more of the plurality of entity-centric latent representations or the corresponding entity-centric position vector associated with each respective entity-centric latent representation.

20. A non-transitory computer-readable medium having stored thereon instructions that, when executed by a computing device, cause the computing device to perform operations comprising:
receiving input data comprising (i) a plurality of feature vectors and (ii), for each respective feature vector of the plurality of feature vectors, a corresponding absolute positional encoding in a reference frame of the input data;
determining a plurality of entity-centric latent representations of corresponding entities represented by the input data;
determining, for each respective entity-centric latent representation of the plurality of entity-centric latent representations, a corresponding relative positional encoding in a reference frame of the respective entity-centric latent representation based on (i) the corresponding absolute positional encoding of each respective feature vector and (ii) a corresponding entity-centric position vector associated with the respective entity-centric latent representation;
determining an attention matrix based on (i) the plurality of feature vectors transformed by a key function, (ii) the plurality of entity-centric latent representations transformed by a query function, and (iii) the corresponding relative positional encoding of each respective entity-centric latent representation;
updating, for each respective entity-centric latent representation of the plurality of entity-centric latent representations, the corresponding entity-centric position vector based on a weighted mean of the corresponding absolute positional encoding of each respective feature vector weighted according to corresponding entries of the attention matrix; and
outputting one or more of the plurality of entity-centric latent representations or the corresponding entity-centric position vector associated with each respective entity-centric latent representation.
